(19) United States
(12) Patent Application Publication
(10) Pub. No.: US 2011/0253909 A1
(43) Pub. Date: Oct. 20, 2011

(54) OPTICAL SENSING VIA CAVITY MODE EXCITATIONS IN THE STIMULATED EMISSION REGIME

(75) Inventors: Michael Himmelhaus, Berlin (DE); Alexandre Francois, Norwood (AU)

(73) Assignee: FUJIREBIO INC., Chuo-ku, Tokyo (JP)

(21) Appl. No.: 13/124,937

(22) PCT Filed: Nov. 9, 2009
(86) PCT No.: PCT/JP2009/069408

§ 371 Date: Jul. 1, 2011

Related U.S. Application Data
(60) Provisional application No. 61/112,410, filed on Nov. 7, 2008.
(60) Provisional application No. 61/140,790, filed on Dec. 24, 2008.

(51) Int. Cl. G21K 5/00

(52) U.S. Cl. 250/492.1

(57) ABSTRACT

A method for analyzing a dense medium with optical cavity modes, comprising the steps of: disposing at least a part of a microlaser into the dense medium; and before, during, or after disposing the part of the microlaser into the dense medium, sensing a condition or a change of the dense medium by means of analysis of optical cavity modes.

U.S. provisional patent application No. 61/018,144 filed on Dec. 31, 2007, PCT application No. PCT/JP2007/059443 filed on Apr. 26, 2007, and U.S. provisional patent application No. 61/111,369 filed on Nov. 5, 2008, are incorporated by reference herein for all purposes.

### TECHNICAL FIELD

The present invention relates to a technology related to an optical sensor based on optical cavity mode excitations in microresonators.

### BACKGROUND ART

Fang et al. (W. Fang et al., Appl. Phys. Lett., Vol. 85, pp. 3666-3668, 2004) detected the adsorption of toluene vapor onto a microlaser surface and calculated the concentration of surface-adsorbed molecules from the resulting wavelength shift.

Zhang et al. (Z. Zhang et al., Appl. Phys. Lett., Vol. 90, pp. 111119/1-3, 2007) fabricated a submicron microdisk laser made within a InGaP/InGaAlP quantum well structure and applied it to refractive index sensing using deionized water and simple alcohols.

Lu et al. (M. Lu et al., Appl. Phys. Lett., Vol. 93, pp. 111113/1-3, 2008) utilized distributed feedback microlasers for detection of polyelectrolyte multilayers and Human IgG antibodies.

### DISCLOSURE OF INVENTION

### Technical Problem

The present invention has been achieved in order to solve the problems which may occur in the related arts mentioned above.

### Technical Solution

One aspect of the invention is a method for analyzing a dense medium with optical cavity modes, comprising the steps of: disposing at least a part of a microlaser into the dense medium; and before, during, or after disposing the part of the microlaser into the dense medium, sensing a condition or a change of the dense medium by means of analysis of optical cavity modes.

### BRIEF DESCRIPTION OF DRAWINGS

FIG. 1 shows a single microresonator or a cluster as an aggregate of microcavities optionally containing a fluorescent material for excitation of optical cavity modes in the microresonator or cluster of microcavities: (a) a single microresonator without a coating; (b) a single microresonator with a coating for achievement of wanted optical properties; (c) a cluster as an aggregate of microcavities without a coating; (d) a cluster as an aggregate of microcavities which are coated in such a way that each cavity is individually coated; and (e) a cluster as an aggregate of microcavities which are coated in such a way that neighboring cavities form optical contacts with each other;

FIG. 2 shows examples of optical set-ups for excitation and detection of optical cavity modes in microresonators: In scheme (I), excitation and detection are pursued through separated light paths; and in scheme (II), the same lens is used for excitation and detection of the cavity modes of the microresonator or microresonators;

FIG. 3 shows in-situ WGM spectra of a 15 μm nile red-doped PS bead in PBS buffer: (a) below the lasing threshold of the bead; (b) above the lasing threshold of the bead; and the inset of (b) the height of the non-lasing fluorescence background above threshold;

FIG. 4 shows the average integrated peak area of the most prominent WGM of 15 μm nile red-doped PS beads in PBS buffer in dependence of the excitation power of the laser used for stimulation of the dye, wherein the open circles represent the measured data, while the dotted and the dash-dotted lines represent fits to the regimes below and above the lasing threshold, respectively, and wherein the inset gives an overview over the entire excitation power range measured (axis labels of the inset are the same as for the main figure);

FIG. 5 shows: (a) average bandwidths of the most prominent WGM of 15 μm nile red-doped PS beads in PBS buffer in dependence of the excitation power of the laser used for stimulation of the dye; and (b) the corresponding quality factors, wherein the onset of lasing is clearly marked by the drop of the bandwidth and the increase of the quality factor;

FIG. 6 shows a BSA adsorption kinetics onto PSS-terminated surfaces measured with 15 μm PS beads operated below threshold at 15 μW excitation power (open squares) and above threshold at 55 μW (open circles); for comparison, the result of an SPR measurement performed under same conditions is shown (dashed line); the inset shows the initial stage of the adsorption process as monitored by a PS bead operated above threshold and SPR, respectively;

FIG. 7 shows optical cavity mode spectra of a 15 μm nile red-doped PS bead in air (I) and in water (II), respectively: upper (I) the spectra below the lasing threshold (a) and above the lasing threshold (b) in air; upper (II) the spectra below the lasing threshold (a) and above the lasing threshold (b) in water; lower (I) blowup of the most intense peak of upper (I); and lower (II) blowup of the most intense peak of upper (II); the legend gives the average power exiting the microscope objective; spectra (b) in upper (I)(II) vertically displaced for clarity;

FIG. 8 shows a sequence of 10 spectra of a 15 μm nile red-doped PS bead in water obtained under lasing condition (from bottom to top): (I) the sequence acquired subsequently at 0.05 s per frame; and (II) the sequence acquired subsequently at 0.011 s per frame; spectra vertically displaced for clarity;

FIG. 9 shows the dependency of the lasing threshold on the repetition rate of the laser used for excitation of WGM lasing in a 15 μm PS bead in air; spectra vertically displaced for clarity;

FIG. 10 shows WGM spectra of two different trimers in water, wherein (a) and (b) are the spectra excited above the lasing threshold, (c) is the spectrum excited below the lasing threshold, and (b) and (c) are the spectrum obtained from the same cluster; spectra vertically displaced for clarity;

FIG. 11 shows WGM spectra obtained from a trimer immersed in water and excited at different locations as indicated in the sketch of the trimer; wherein (a) central excitation, (b) excitation of upper left bead, (c) excitation of lower left bead, and (d) excitation of right bead (all other parameters, in particular excitation intensity, kept constant; spectra show untreated raw data for direct comparison of WGM intensities); spectra vertically displaced for clarity;

FIG. 12 shows WGM spectra of 15 μm PS beads, wherein (a) beads doped with Nile red (upper half) or alternatively doped with C6G and Nile red (lower half) were excited with 442 nm radiation or (b) were excited with 532 nm radiation; spectra (b) slightly vertically displaced for clarity;

FIG. 13 shows normalized WGM spectra of a mixed dimer comprised of one bead doped with Nile red only and one bead doped with C6G and Nile red, wherein (a) the dimer was centrally excited by 442 nm radiation, (b) the dimer was centrally excited by 532 nm radiation below threshold, and (c) the dimer was centrally excited by 532 nm radiation above the lasing threshold. spectra vertically displaced for clarity;

FIG. 14 shows a real-time series (1 s intervals as indicated by the respective labels) of WGM spectra of a Nile red-doped 15•m PS microlaser freely floating in a 10% BSA/PBS solution, while it passes through the focus of a 40× objective applied for excitation and detection according to scheme 2 of FIG. 2; spectra vertically displaced for clarity; shown are untreated raw data for direct comparison of peak intensities;

FIG. 15 shows a comparison of WGM spectra obtained from Nile red-doped 15•m PS microlasers freely floating in 10% BSA/PBS solution (a, c) or resting on the substrate surface in the same solution (b, d); (I) repetition rate of excitation laser 10 kHz; (II) repetition rate of excitation laser 500 kHz; average excitation power in both cases about 50•W; spectra vertically displaced for clarity; shown are untreated raw data for direct comparison of peak intensities;

FIG. 16 shows (I) WGM spectra of a surface-adsorbed Nile red-doped 15•m PS microlaser in 10% BSA/PBS solution, which did not show lasing under any of the conditions applied in FIG. 15, excited at an average power of about 50•W and exposed to the following conditions: (a) 500 kHz repetition rate of the excitation laser and 40× objective used for focusing and light collection (according to scheme 2 of FIG. 2); (b) 500 kHz and 100× objective; (c) 10 kHz and 40× objective; (d) 10 kHz and 100× objective; (II) blow-up of spectra (a-c) of (I); spectra vertically displaced for clarity; and

FIG. 17 shows WGM spectra above lasing threshold of Nile red-doped 15•m PS microlasers embedded into solid-phase gelatin prepared from a 5% (a) and a 3% (b) gelatin/water solution, respectively; spectra vertically displaced for clarity.

### BEST MODE FOR CARRYING OUT THE INVENTION

Exemplary embodiments relating to the present invention will be explained in detail below with reference to the accompanying drawings.

### DEFINITION OF TERMS

BSA: Bovine Serum Albumin
C6G: Coumarin 6 laser grade
FPM: Fabry-Perot mode
OEG: Oligo(ethylene glycol)
PAA: Poly(acrylic acid)
PAH: Poly(allylamine hydrochloride)
PBS: Phosphate Buffered Saline
PEG: Poly(ethylene glycol)
PS: Poly(styrene)
PSS: Poly(sodium 4-styrenesulfonate)
Q-Factor: Quality factor
SPR: Surface plasmon resonance
TIR: Total Internal Reflection
TE: Transverse Electric optical mode
TM: Transverse Magnetic optical mode
WGM: Whispering gallery mode

Reflection and transmission at a surface: In general, the surface of a material has the ability to reflect a fraction of impinging light back into its ambient, while another fraction is transmitted into the material, where it may be absorbed in the course of its travel. In the following we call the power ratio of reflected light to incident light the “Reflectivity” or “Reflectance”, R, of the ambient/material interface (or material/ambient interface). Accordingly, the power ratio of transmitted light to incident light is called the “Transmittance”, T, of this interface. Note, that R and T both are properties of the interface, i.e., their values depend on the optical properties of both, the material and its ambient. Further, they depend on the angle of incidence and the polarization of the light impinging onto this interface. Both R and T can be calculated by means of the Fresnel equations for reflection and transmission.

Optical cavity: An optical cavity is a closed volume confined by a closed boundary area (the “surface” of the cavity), which is reflective to light in the ultraviolet (UV), visible (vis) and/or infrared (IR) region of the electromagnetic spectrum. Besides its wavelength dependence, the reflectance of this boundary area may also be dependent on the incidence angle of the light impinging on the boundary area with respect to the local surface normal. Further, the reflectance may depend on the location, i.e., where the light impinges onto the boundary area. The inner volume of the optical cavity may consist of vacuum, air, or any material that shows high transmission in the UV, visible, and/or IR. In particular, transmission should be high at least for a part of those regions of the electromagnetic spectrum, for which the surface of the cavity shows high reflectance. An optical cavity may be coated with a material different from the material of which the optical cavity is made. The material used for coating may have, e.g., different optical properties, such has different refractive index or absorption coefficient. Further it may comprise different physical, chemical, or biochemical properties than the material of the optical cavity, such as different mechanical strength, chemical inertness or reactivity, and/or antifouling or related biofunctional functionality. In the following, this optional coating is referred to as “shell”, while the optical cavity is called “core”. Further, the total system, i.e., core and shell together, are referred to as “(optical) microresonator”. The latter term is also used to describe the total system in the case that no shell material is applied. For assemblies or aggregates of optical cavities and microresonators, the term “optical cavities or microresonators” refers to any arbitrary number of both kinds of cavities, i.e., with and without shell. In such case, some of the optical cavities may form optical contacts with each other, some may not. In addition to the shell discussed here, a part of the surface of the microresonator may be coated with additional layers (e.g., on top of the shell) as part of the sensing process, for example to provide a suitable biofunctional interface for detection of specific binding events or in the course of the sensing process when target molecules adsorb on the microresonator surface or a part of it.

An optical cavity (microresonator) is characterized by two parameters: First, its free spectral range (FSR) δλ (or, alternatively, its volume V in terms of size and geometry of the optical cavity (microresonator)), and second, its quality factor Q. In the following, the term “optical cavity” (“microresonator”) refers to those optical cavities (microresonators) with a quality factor Q>1. Depending on the shell material used, the light stored in the microresonator may be stored in the optical cavity solely, e.g., when using a highly reflective metal shell, or it may also penetrate into the shell, e.g., when using a dielectric or semiconducting shell. Therefore, it depends on the particular system under consideration, which terms (FSR (or volume) and Q-factor of the optical cavity or those of the microresonator) are more suitable to characterize the resulting optical properties of the microresonator.

Free spectral range (FSR): The free spectral range δλ of an optical system refers to the spacing between its optical modes. For an optical cavity, the FSR is defined as the mode spacing, δλₘ=λₘ−λₘ₊₁, where m is the mode number and λₘ>λₘ₊₁. The FSR may depend on the optical cavity modes under consideration. For example, it may depend on their frequencies, the direction of their propagation and/or their polarization. Analogously, for an interferometer, the FSR is the spacing between neighboring orders of intensity maxima (or minima, respectively).

Quality factor: The quality factor (or “Q-factor”) of an optical cavity is a measure of its potential to trap photons inside of the cavity. It is defined as

$$Q = \frac{stored energy}{loss per roundtrip} = \frac{{ω}_{m}}{{Δω}_{m}} = \frac{{λ}_{m}}{{Δλ}_{m}} \qquad ( 1 )$$

where ωₘ and λₘ are frequency and (vacuum) wavelength of cavity mode with mode number m, respectively, and Δωₘ and Δλₘ are the corresponding bandwidths. The latter two equations connect the Q-factor with position and bandwidth of the optical modes inside of the cavity. Obviously, the storage potential of a cavity depends on the reflectance of its surface. Accordingly, the Q-factor may be dependent on the characteristics of the cavity modes, such as their wavelength, polarization, and direction of propagation.

Volume of an optical cavity: The volume of an optical cavity is defined as its inner geometrical volume, which is confined by the surface of the cavity, i.e., the reflective boundary area.

Globular volume: A volume is called “three-dimensional” or “globular” in the following if none of the three dimensions, such as length, width, and height, of the smallest possible of all arbitrarily chosen rectangular boxes that fully engulf the volume has an extension that is smaller than 10% of the extensions of its other two dimensions. The term “smallest box” in this context refers to the box with the smallest volume of all those fully engulfing the volume under consideration. Accordingly, a volume is called “two-dimensional” or “disk-like” in the following if one and only one of the three dimensions, such as length, width, and height, of the smallest possible of all arbitrarily chosen rectangular boxes that fully engulf the volume has an extension that is smaller than 10% of the extension of the smaller one of its other two dimensions. Finally, a volume is called “one-dimensional” or “linear” in the following if one and only one of the three dimensions, such as length, width, and height, of the smallest possible of all arbitrarily chosen rectangular boxes that fully engulf the volume has an extension that is at least ten times larger than the larger one of the extensions in its other two dimensions. For sake of brevity, optical cavities or microresonators or clusters thereof or lasers or microlasers will be called “one-dimensional systems” or “two-dimensional systems” or “three-dimensional systems” if their volumes are one- or two- or three-dimensional, respectively. The size of a volume (e.g., optical cavity, microresonator, resonator, or microlaser) refers to the extension of its largest dimension according to the definitions given above.

Ambient (environment) of an optical cavity or microresonator. The “ambient” or “environment” of an optical cavity or microresonator is that volume enclosing the cavity (microresonator), which is neither part of the optical cavity, nor of its optional shell (in the case of a microresonator). In particular, the highly reflective surface of the optical cavity (or microresonator) is not part of its ambient. It must be noted that in practice, the highly reflective surface of the optical cavity (microresonator) has a finite thickness, which is not part of the ambient. The same holds for the optional shell, which has also a finite thickness and does not belong to the microresonator's ambient. The ambient or environment of an optical cavity (microresonator) may comprise entirely different physical and chemical properties from that of the cavity (microresonator), in particular different optical, mechanical, electrical, and (bio-) chemical properties. For example, it may strongly absorb in the electromagnetic region, in which the optical cavity (microresonator) is operated. The ambient may be heterogeneous. The extension to which the enclosing volume is considered as ambient, depends on the application. In the case of a microresonator (microlaser) brought into a microfluidic device, it may be the microfluidic channel. If the microresonator (microlaser) is brought into a dense medium, it may be that volume affected, exposed, or influenced by the radiation of the microlaser. Typically, the ambient is that part of the enclosing volume of the optical cavity or microresonator, which is of relevance for the optical cavity's (microresonator's) operation, for example in terms of its impact on the optical cavity modes of the cavity (microresonator) in view of their properties, excitation, and/or detection.

Optical cavity mode: An optical cavity mode or just “cavity mode” is a wave solution of the electromagnetic field equations (Maxwell equations) for a given optical cavity or microresonator. Different cavity modes may have different directions of propagation, different polarizations, different frequencies (wavelengths), bandwidths, phases, field strengths, and/or intensities depending on geometry and optical properties of the optical cavity or microresonator. These modes are discrete (i.e., countable) and can be numbered, e.g., with integers, due to the restrictive boundary conditions imposed by the optical cavity or microresonator. Accordingly, the electromagnetic spectrum in presence of the optical cavity (microresonator) can be divided into allowed and forbidden zones. The wave solutions depend on the shape and volume of the cavity as well as on the reflectance of the boundary area, i.e., the cavity surface, which may be heterogeneous, i.e., exhibit different optical properties, such as different reflectance, at different locations.

The complete solutions of the Maxwell equations for a given optical cavity (microresonator) consist of internal and external electromagnetic fields inside and outside of the optical cavity (microresonator), respectively. For the fields outside, i.e., in the ambient of the optical cavity (microresonator), two kinds of solutions must be distinguished: those where the solutions describe freely propagating waves in the ambient and those where the solutions describe evanescent fields. The latter come into existence for waves, for which propagation in the ambient is forbidden, e.g., due to total internal reflection at the surface of the optical cavity (microresonator). One example for optical cavity modes that comprise evanescent fields in the ambient are WGMs. Another example is related to microresonators with a metal coating as shell. In such cases, in addition to freely propagating waves that may exist due to the finite reflectivity of the metallic shell, surface plasmons may be excited at the metal/ambient interface, which also may exhibit an evanescent field extending into the ambient (M. Himmelhaus, Proc. SPIE Vol. 6862, pp. 68620U/1-8, 2008). In all these cases the evanescent field extents into the ambient typically for a distance roughly of the order of the wavelength of the wave (e.g., light wave or charge density oscillation) generating the evanescent field.

It should be noted that in practice, also evanescent fields may show some leakage, i.e., propagation of photons out of the evanescent field into the far field of the optical cavity, i.e., far beyond the extension of the evanescent field into the ambient. Such waves are caused, for example, by scattering of photons at imperfections or other kinds of causes, which are typically not accounted for in the theoretical description, since the latter typically assumes smooth interfaces and boundary layers. Such stray light effects are not considered in the following, i.e., do not hamper the evanescent field character of an ideally evanescent field. In the same way, evanescent field tunneling across a nanometer-sized gap into a medium, in which wave propagation is then allowed, such as a prism, waveguide, or near-field probe, does not hamper the evanescent field character of the evanescent field.

For spherical cavities, there exist two main types of solutions, for which the wavelength dependence can be easily estimated, one for light propagation in radial direction and one for light propagation along the circumference of the sphere, respectively. In the following, we will call the modes in radial direction “Fabry-Perot Modes” (FPM) due to analogy with Fabry-Perot interferometers. The modes forming along the circumference of the spheres are called “Whispering Gallery Modes” (WGM) in analogy to an acoustic phenomenon. For a simple mathematical description of the wavelength dependence of these modes, we use stationary boundary conditions in the following:

$${λ}_{m} = \frac{4 R {n}_{cav}}{m} , m = 1 , 2 , 3 , … \qquad ( 2 )$$

for FPM, which states that the electric field at the cavity surface as to vanish for all times, as is the case e.g., for a cavity with a metallic surface or shell. For WGM, a simple periodic boundary condition yields

$${λ}_{m} = \frac{2 π R {n}_{cav}}{m} , m = 1 , 2 , 3 , … \qquad ( 3 )$$

which basically states that the wave has to return in phase after a full roundtrip. In both formulas, “m” is an integer and is also used for numbering of the modes, i.e., as their mode number, R is the sphere radius, and n_{cav} the refractive index inside of the cavity. For sake of brevity, in the following the term “cavity mode m” will be used synonymously with the term “cavity mode with mode number m”.

From equations (2) and (3), the FSR δλₘ of FPM and WGM, respectively, of spherical cavities can be calculated to

$${δλ}_{m} = \frac{{λ}_{m}}{m + 1} = \frac{{λ}_{m + 1}}{m} \qquad ( 4 )$$

An optical cavity mode will be called “operable” in the following, if it can be excited and detected by the means applied for excitation and detection (analysis) of optical cavity modes in a given set-up, device, or system.

Dense medium: A substance or material that may be gaseous, liquid, or solid, or have any other condensed matter, such as liquid-crystalline, with a refractive index>1.1. In particular, the dense medium may be heterogeneous and consist of a plurality of substances and materials. In such case, the medium is a dense medium, if one of its components has a refractive index>1.1.

Mode coupling: We define mode coupling as the interaction between cavity modes of two or more optical cavities or microresonators that are positioned in contact with each other or in close vicinity to allow an optical contact. This phenomenon has been pointed out by S. Deng et al. (Opt. Express Vol. 12, pp. 6468-6480, 2004), who have performed simulations on mode guiding through a series of microspheres. The same phenomenon has been experimentally demonstrated by V. N. Astratov et al. (Appl. Phys. Lett. Vol. 83, pp. 5508-5510, 2004), who used a chain of non-fluorescent microspheres as waveguide and a single fluorescent microsphere positioned at one end of the microsphere waveguide in order to couple light into the chain. They have shown that the cavity modes produced by the fluorescent microsphere under excitation can propagate along the non-fluorescent microsphere chain, which means that light can be coupled from one sphere to another. The authors related this coupling from one microsphere to another to “the formation of strongly coupled molecular modes or crystal band structures”.

T. Mukaiyama et al. (Phys. Rev. Lett. Vol. 82, pp. 4623-4626, 1999) have studied cavity mode coupling between two microspheres as a function of the radius mismatch between the microspheres. They have found that the resulting cavity mode spectrum of the bi-sphere system is highly depending on the radius mismatch of the two microspheres. More recently, P. Shashanka et al. (Opt. Express Vol. 14, pp. 9460-9466, 2006) have shown that optical coupling of cavity modes generated in two microspheres can occur despite of a large radius mismatch (8 and 5 μm). They have shown that the coupling efficiency depends strongly on the spacing between the two microspheres and as a result, the positions of the resonant wavelengths also depend on the microsphere spacing.

Further, optical cavity modes of optical cavities or microresonators in close vicinity of each other may be mutually altered by the presence of the neighboring optical cavities or microresonators, e.g., exhibit different frequencies, bandwidths, and/or directions of propagation as compared to the isolated optical cavity or microresonator in absence of its neighbors. This may happen, for example, if the optical cavities or microresonators come so close to each other that they share their evanescent fields. In such case, they may sense each other with corresponding changes in their respective optical cavity modes. For sake of simplicity, also this effect will be included into the term “mode coupling” in the following.

Optical contact: Two optical cavities or microresonators are said to have an “optical contact”, if light can transmit from one cavity or resonator to the other one. In this sense, an optical contact allows potentially for mode coupling between two optical cavities or microresonators in the sense defined above. Accordingly, an optical cavity or microresonator has an optical contact with the substrate if it may exchange light with it.

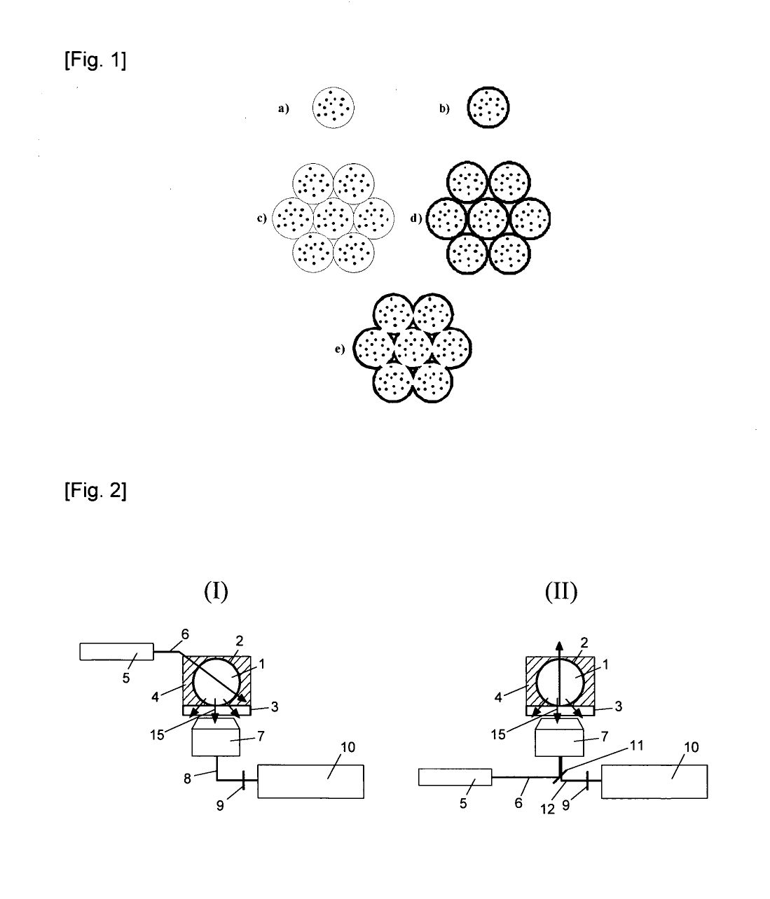

Clusters: A cluster is defined as an aggregate of optical cavities and/or microresonators of arbitrary and optionally different geometry and shape, which may be formed either in a one-, two-, or three-dimensional fashion (cf. FIG. 1). The individual optical cavities or microresonators are either positioned in such a way that neighboring optical cavities and/or microresonators are in contact with each other or in close vicinity in order to promote the superposition of their optical cavity mode spectra and/or mode coupling. Microresonators and/or optical cavities in contact may be in physical contact, i.e., touching each other, or, e.g., in optical contact as defined above. Microresonators and/or optical cavities in close vicinity to each other may be sufficiently close for superposition of their evanescent fields, which extent typically some hundreds of nanometers from their surface into the ambient, or sufficiently close for collective excitation and/or detection of their cavity mode spectra (independent of the timing of such collective excitation and/or detection).

Alternatively, a cluster of microresonators and/or optical cavities is an aggregate of arbitrary geometry and shape of microresonators and/or optical cavities of arbitrary and optionally different geometry and shape, which is collectively operated, e.g., in which optical cavity modes are collectively excited and/or collectively detected. However, the term “collectively” is meant to be independent of the timing of excitation and/or detection, which may be performed in a parallel fashion (e.g., by simultaneous exposure of the entire cluster(s) to the excitation radiation and/or detection of the optical cavity mode spectra by means of an in parallel operating (multichannel) detection device, such as a detector array or a CCD camera) or in a serial way by scanning either the light source(s) and/or detector(s) through the wanted spectral range. Also, combinations of these parallel and serial schemes as well as more complex timing sequences are feasible. In this sense, a cluster of microresonators and/or optical cavities can also be viewed as an aggregate of arbitrary geometry and shape of microresonators and/or optical cavities of arbitrary and optionally different geometry and shape, which exhibits a characteristic spectral fingerprint when probed under suitable conditions (independent of the timing and/or other relevant conditions). It should be further noted that the microresonators and/or optical cavities comprising the cluster may have different optical, physical, chemical and/or biological function and also bear different kinds of shells or other coatings of different function. For example, they may exhibit different kinds of optical cavity mode spectra (e.g., FPM or WGM), which may be excited by different optical mechanisms (e.g., via evanescent field coupling or by excitation of one or different kinds of fluorescent material(s)). As already stated above, independent of its composition, the only crucial criterion is that the cluster exhibits a characteristic spectral fingerprint when probed and analyzed under suitable conditions.

A cluster may be further prepared in such way, that the optical cavity modes of at least some of the different optical cavities or microresonators constituting the cluster may be analyzed independently from each other. This may be achieved, for example, by utilization of more than one active medium, for example, with different and/or with some of the optical cavities or microresonators constituting the cluster.

Some examples of clusters are shown in FIG. 1. The individual optical cavities may be attached to a surface or float freely in a medium. Further, they may be—at least temporally—detached from a surface. The individual optical cavities may be coated as described above in either such a way that each cavity is individually coated (FIG. 1(d)) or in such a way that neighboring cavities within a cluster form optical contacts with each other (FIG. 1(e)). In the latter case the optical cavities comprising the cluster may share a common shell, while this shell may be heterogeneous in nature. The cluster may be formed randomly or in an ordered fashion for example using micromanipulation techniques and/or micropatterning and/or self-assembly. Further, the clusters may form in the course of a sensing process, for example inside of a medium, such as a live cell, after penetration of cavities (microresonators) into the medium to facilitate sensing of the wanted physical, chemical, biochemical, and/or biomechanical property. Also, combinations of all schemes shown in FIG. 1 are feasible. In general, the clusters of particles can be distributed over the surface in a random or an ordered fashion, which may be either in one-, two- or three-dimensional structures. Thereby, photonic crystals may be formed.

Active medium: An active medium is a medium that is capable of light emission and that can be used to excite (generate) optical cavity modes in an optical cavity or microresonator, when powered and/or stimulated in a suitable fashion.

Gain medium: A gain medium is the active medium that is capable of light emission via stimulated emission and that may induce lasing in an optical cavity or microresonator under suitable conditions, e.g., when powered and stimulated in a suitable fashion.

Active (micro-)resonator (optical cavity): An optical cavity or microresonator or optical resonator in general with a gain medium for operation of the optical cavity or microresonator or optical resonator above lasing threshold is called an “active optical cavity” or “active microresonator” or “active optical resonator”.

Passive (micro-)resonator (optical cavity): An optical cavity or microresonator or optical resonator in general without any gain medium for operation of the optical cavity or microresonator or optical resonator above lasing threshold is called an “passive optical cavity” or “passive microresonator” or “passive optical resonator”.

Laser: A laser is an optical device that amplifies light by stimulated emission of its gain medium. An active optical cavity, active microresonator or active optical resonator in general may become a laser when operated under suitable conditions, e.g., by powering its gain medium in such fashion that the lasing threshold is reached or surpassed.

Microlaser: A microlaser is a laser utilizing an optical cavity or microresonator as resonant structure for light recirculation and amplification, wherein the optical cavity or microresonator has a three-dimensional volume, wherein the largest extension of this volume in three dimensions has a value of 50 μm or below. For determination of this size, the same method can be applied as for the determination of the character of the volume (cf. definition of the term “globular volume”), i.e., none of the three dimensions (length, width, and height) of the smallest possible of all arbitrarily chosen rectangular boxes that fully engulf the volume of the optical cavity or microresonator has an extension of above 50 μm. Accordingly, cluster of microlasers is a cluster of optical cavities and/or microresonators wherein at least one constituent of the cluster is a microlaser.

Lasing: Light amplification by stimulated emission is called “lasing”.

Lasing threshold: The threshold for stimulated emission of an (active) optical cavity or microresonator, also called the “lasing threshold”, is defined as the (e.g., optical, electrical, or electromagnetical) pump power of the (active) optical cavity or microresonator where the light amplification via stimulated emission just compensates the losses occurring during propagation of the corresponding light ray within the optical cavity or microresonator. Since the losses for light rays traveling within a cavity mode are lower than for light rays that do not match a cavity mode, the cavity modes exhibit typically the lowest lasing thresholds (which may still differ from each other depending on the actual losses of the respective modes) of all potential optical excitations of an optical cavity or microresonator. In practice, the lasing threshold can be determined by monitoring the optical output power of the optical cavity or microresonator (e.g., for a specific optical cavity mode) as a function of the (e.g., optical, electrical, or electromagnetical) pump power used to stimulate the gain medium of the cavity or microresonator. Typically, and as shown in Example 1 of the present embodiment, the slope of this dependence is (significantly) higher above than below the lasing threshold so that the lasing threshold can be determined from the intersection of these two dependencies. When talking about the “lasing threshold of an optical cavity or microresonator”, one typically refers to the lasing threshold of that optical cavity mode with the lowest threshold within the observed spectral range. Analogously, the lasing threshold of a cluster of optical cavities or microresonators addresses the lasing threshold of that optical cavity mode within the cluster with the lowest threshold under the given conditions.

Interferometry: Interferometry is the technique of using the pattern of interference created by the superposition of two or more waves to diagnose the properties of the aforementioned waves. The instrument used to interfere the waves together is called an “interferometer”. In the plane of observation, an interferometer produces a pattern of varying intensity, which originates from the interference of the superposed waves. Typically, the pattern exhibits circular symmetry and consists of a center spot surrounded by bright (and dark) rings. It is therefore referred to as “fringe pattern”. The center spot is called “central fringe”.

Analysis of Optical Cavity Modes: According to the definitions above, optical cavity modes provide information about the optical cavity (-ies) or microresonator(s), in which they are generated, with respect to the cavity's (-ies') or microresonator's (-s') geometry (as expressed, e.g., by the FSRs, the mode spacings and mode properties in general, in terms of their frequencies, bandwidths, polarizations, directions and kinds of propagation, field strengths, phases, intensities, etc.), optical trapping potential for a certain wavelength and/or polarization (as expressed e.g., by the respective Q-factor), and the cavity's (cavities') or microresonator's (-s') physical condition, its (their) ambient(s), and/or interaction(s) with its (their) ambient(s) (as expressed e.g., by appearance, disappearance, increase or decrease in field strength(s) or intensity (-ies), change of phase(s) or polarization(s), broadening, shifting, and/or splitting of cavity modes).

All this information may be revealed by analysis of optical cavity modes with respect to the measurement of their properties, such as mode positions (frequencies), mode spacings, mode occurrences, field strengths, phases, intensities, bandwidths, Q-factors, polarizations, directions and kinds of propagation, and/or changes thereof. The term “analysis of optical cavity modes”, which will be used for the sake of brevity in the following, comprises all kinds of measurements, which allow the determination of one or more of these mode properties or changes thereof.

### DESCRIPTIONS OF EMBODIMENTS

Microresonators (accordingly, optical cavities; in the following, the latter term will be omitted for sake of brevity but may be substituted or amended wherever suitable) confine light to small volumes by resonant recirculation and have demonstrated potential use as microscopic light emitters, lasers, and sensors (K. J. Vahala, Nature 424, pp. 839-846, 2003). The light (radiation) recirculation imposes geometry-dependent boundary conditions on wavelength, polarization, and propagation direction of the light kept inside the microresonator. Accordingly, only certain optical modes, the so-called “cavity modes”, can be populated. Since the energy levels of these allowed modes depend crucially on geometry and optical properties of the microresonators, the latter comprise very sensitive microscopic optical sensors that can be used for example to sense forces (e.g., by deformation of the cavity (M. Gerlach et al., Optics Express 15, 6, pp. 3597-3606, 2007)) or changes in chemical concentration (W. Fang et al., Appl. Phys. Lett. Vol. 85, pp. 3666-3668, 2004). Similarly, microresonators can be used for biomolecular detection, e.g., by absorption of specifically binding molecules to or into a microresonator and detecting the resultant change of the refractive index around or inside of the cavity (F. Vollmer et al., Applied Physics Letters 80, pp. 4057-4059, 2002; V. S. Ilchenko & L. Maleki, Proc. SPIE, Vol. 4270, pp. 120-130, 2001).

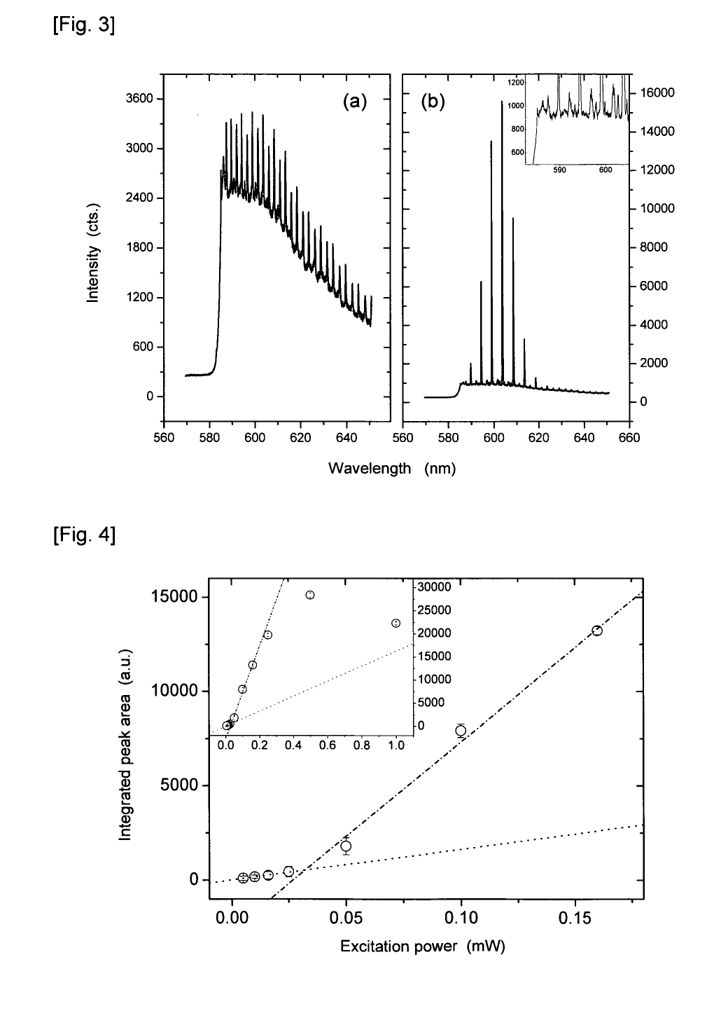

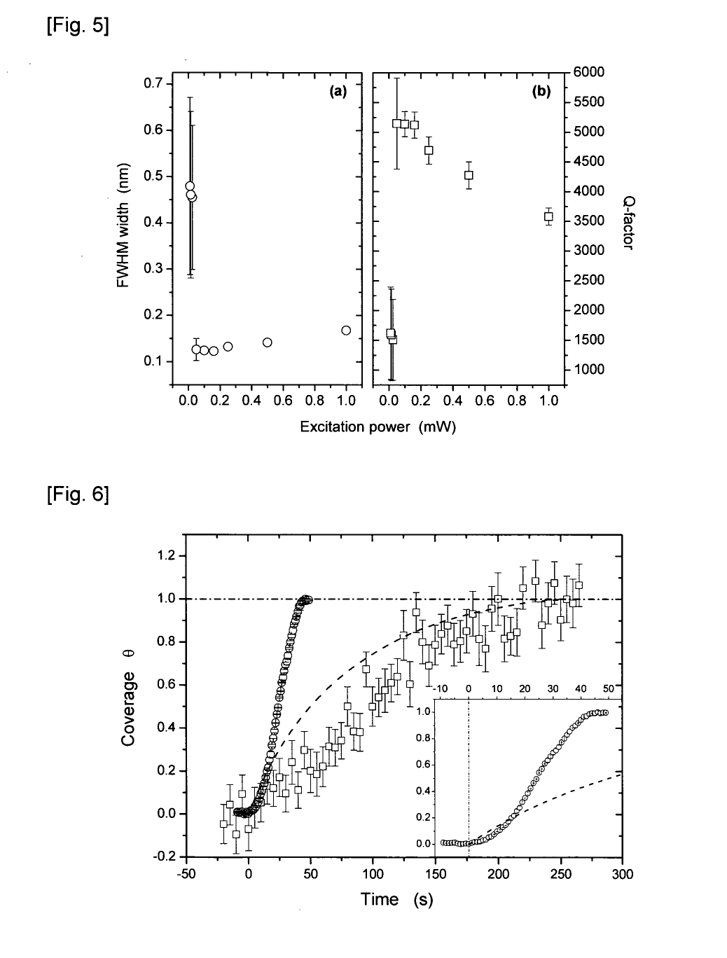

Microresonators can be operated either in a passive fashion, e.g., by optical coupling to an external light source, or in an active fashion, e.g., by incorporation of an active medium that serves as light source in the wanted operation regime of the microresonator once powered suitably. In the case that the active medium is a gain medium, the microresonator may be operated above the lasing threshold, i.e., may amplify light at least within the regime of at least one of its optical cavity modes. As exemplified in FIGS. 3 and 4, the amplified optical cavity modes show typically a significant increase in their emission intensity, improving the signal-to-noise (S/N) ratio accordingly. Further, they show typically a narrowing of their bandwidths, Δλ, as compared to their operation below threshold (FIG. 5; for details on FIGS. 3-5 see Example 1). Both effects may be beneficially exploited for sensing applications, since both may improve the detection limit of sensors based on optical cavity mode excitations.

As transducer mechanism for optical sensing due to external stimuli, typically either shifts in optical cavity mode positions or their changes in bandwidth are utilized. Obviously, an increased S/N ratio will allow a better determination of both effects. Also, a narrowing of the modes' bandwidths will allow the detection of smaller shifts as well as of more subtle changes in their bandwidths, so that both effects related to the lasing regime, i.e., improved S/N ratio and reduced bandwidth, will add beneficially to the performance of the sensors (F. Vollmer and S. Arnold, Nature Meth. Vol. 5, pp. 591-596, 2008; V. S. Ilchenko and L. Maleki, Proc. SPIE Vol. 4270, pp. 120-130, 2001).

Improved S/N ratio and smaller bandwidths are general characteristics of active (i.e., containing a gain medium) optical resonators operated above lasing threshold. And accordingly, lasers in general are of utmost importance for a variety of sensing applications, ranging from distance measurements and position control to chemical and biochemical sensing, to give just a few examples.

Today, however, many sensing applications do not only require high precision in the measurements, but also a small size of the sensor. Small, and even microscopic sensors with total sizes below one millimeter offer the opportunity of highly localized sensing, which may be very important in many different fields of technology. In combustion research, for example, the behavior of a reactive flow depends severely on its initial conditions. For comparison of numerical flow field simulations with the experiments, a precise determination of the initial conditions with high spatial resolution is of utmost importance. The same arguments hold for chemical and biochemical reactions in liquid ambients.

In this context, it should be noted that a “small sensor” does not only mean “small sensing area” but also mean minuteness of the transducer or sensor as a whole, since a large periphery of an otherwise small sensing area would still cause significant distortions to the ambient of the sensing location, which then might significantly change the evolution of the system under study.

For these reasons, a lot of effort has been put into the miniaturization of active optical resonators for sensing applications. For example, Cunningham et al. (B. T. Cunningham et al., J. Biomolecul. Screen., Vol. 9, pp. 481-490, 2004) implemented vertically emitting distributed feedback lasers for biosensing applications. However, while the DFB laser structure can be made very thin, its lateral extension can be scaled down only to limited extent due to the presence of the Bragg grating, which requires a minimum number of periodical repetition units to achieve sufficient gain and sufficiently small bandwidths of the lasing modes. Cunningham et al., for example, state in their article that an area of about 2 mm in diameter was illuminated on the grating surface for operation of the system (This dimension can also be calculated from the resolving power R of a diffraction grating with N lines operated in mth order and with a grating constant g, which is given by R=•/••=m N. With •=588.3 nm, ••=0.09 nm, m=1, and g=400 nm as given by the authors (M. Lu et al., Appl. Phys. Lett. Vol. 93, pp. 111113/1-3, 2008), the minimum lateral extension of the distributed feedback laser can be calculated to Lₘᵢₙ=g×N=g×•/••=2.6 mm). Therefore, with their thickness of about 100 •m, these systems are basically two-dimensional systems and further are not “small sensors” in the sense of the present invention.

In contrast to such open systems, the embodiments of the present invention apply closed resonators, i.e., a small volume confined by a closed boundary area, i.e., the surface of the resonator, which confines light inside the volume by reflection. The reflectance of the resonator surface may be different at different locations and be different for different optical frequencies, polarizations, and incidence angles. This kind of resonators can be significantly scaled down, mainly limited by their operation wavelength and technological limitations of fabricating such small resonators with sufficient quality, e.g., with respect to the reflectance of their surface.

Recently, a number of groups succeeded in the fabrication of small, closed-volume resonators structured into semiconductor substrates in a basically monolithic fashion. Fang et al. structured microdisks into the natural SiO₂ layer of a silicon wafer and used them for detection of toluene vapors in a flow of nitrogen (W. Fang et al., Appl. Phys. Lett., Vol. 85, pp. 3666-3668, 2004). Zhang et al. (Z. Zhang et al., Appl. Phys. Lett., Vol. 90, pp. 111119/1-3, 2007) fabricated submicron microdisks in InGaAlP that contained InGaP quantum wells as gain medium and applied the resulting submicron laser to refractive index sensing of simple alcohols and deionized water.

While their feasibility for sensing thus has been demonstrated, these microdisk lasers exhibit some severe disadvantages due to their shape as well as the materials they are made of. For example, their disk shape does not allow them to be detached from their substrate for use as freely floating remote sensors. The reason is that the disk is a basically two-dimensional structure, which is likely to stick to any surface it comes into contact with due to its high surface-to-volume ratio and thus the dominance of surface interactions. Further, the disk allows mode excitation only within the plane of the disk, i.e., in two dimensions. Therefore, a disk freely floating in a medium, which would supposedly undergo arbitrary rotations and spins along its in-plane symmetry axes, would frequently probe different sections of its immediate ambient and thus—if this ambient is heterogeneous—give different sensor signals depending on its orientation. Such frequent changes in the signal are supposedly difficult to interpret, in particular because the motion of a submicron disk is supposedly difficult to track. A problem which is more severe than these practical issues, however, is the limited stability of semiconductor materials (V. Kümmler et al., Appl. Phys. Lett. Vol. 84, pp. 2989-2991, 2004; T. Schoedl and U. T. Schwarz, J. Appl. Phys. Vol. 97, pp. 123102/1-8, 2005) because of their typically high reactivity, e.g., due to the presence of electron-hole pairs, which may induce unwanted processes, such as chemical reactions. For example, as stated in their article, the InGaP/InGaAlP microdisk structure of Zhang et al. (Appl. Phys. Lett., Vol. 90, pp. 111119/1-3, 2007) is amenable to oxidation even in ambient air. Under more severe conditions, such as the aqueous phases typically needed in biosensing, these structures are very likely exposed to a rapid decay of their optical properties.

To overcome these intricacies and to enable the use of closed-volume optical cavities or microresonators of sufficiently small size for highly localized measurements, the inventors of the present invention realized that the difficulties in the related art can be overcome by utilization of three-dimensional resonators of small size. In this context, a three-dimensional volume is a volume where the different dimensions, like length, height, and width, are all of the same order, even if the coordinate system for their determination is arbitrarily chosen. That is, there is no dimension, in which the extension of the volume is smaller by one order of magnitude than in the other two dimensions (for a detailed definition of the term, see “Definition of terms” section). One example of such globular resonator is a sphere. In the case of a surface with uniform optical properties, the sphere will support the excitation of optical cavity modes in different directions. For example, in the case of a dielectric sphere in a medium with sufficiently low refractive index, WGM can be excited inside of the sphere in an arbitrarily chosen plane intersecting the center of the sphere. Such a sphere, freely floating in a medium, would therefore sense the medium in a homogeneous fashion without distortion due to frequent changes of the orientation of the plane of WGM excitation. Further, due to the high symmetry, such globular object is more difficult to bring into rotation around any of its symmetry axes by random or fluctuating forces than a two-dimensional object. Therefore, a globular resonator may be used for remote sensing and may freely float in a medium without impairment of its transducer signal.

Since the process of sensing should be highly spatially confined, e.g., to provide information about a physical or chemical property of the medium at high spatial resolution or to allow a high density of sites of measurements, e.g., for applications in array sensing, the inventors utilized globular resonators with a dimension of or below 50 μm. Such resonators, which may be comprised of an optical cavity or microresonator, depending on whether the optical cavity bears a shell or not, will be provided with a suitable gain medium and used as microlasers in the following.

It should be noted that spherical volumes are not the only suitable ones as long as the volume is three-dimensional. An ellipsoid, a cuboid, or other kind of protrude structure, for example, can easily be stabilized, e.g., by optical tweezers, even if not supported by a substrate. It may be even wanted to relate the different geometry in different dimensions to different kinds of optical cavity mode excitations, such as excitations differing in frequency, polarization, the extension of their evanescent fields, or the direction of their propagation, e.g., for multiplexed sensing or to introduce a reference system not amenable to the change in the ambient that is the target of the measurement.

Also, a globular resonator, which is intrinsically a system that does not require the support of a substrate, nevertheless may be deposited on a suitable substrate, e.g., to allow measurements in immediate vicinity of the surface, i.e., to bring the resonator into contact with at least a surface of the medium to be sensed, or to facilitate multiplexed sensing (e.g., in the case that many resonators are placed on the same substrate and operated sequentially or simultaneously). In contrast to the two-dimensional microdisks mentioned above, which were fabricated in a monolithic fashion to achieve their proper operation and thus rest above the surface in a predefined fashion with respect to their distance and orientation towards the surface, a globular resonator may be deposited on a substrate after its fabrication and after conditioning or functionalization of its sensing area, i.e., after enabling the sensing area to sense the wanted property or target in its ambient. For example, globular resonators may first be fabricated, decorated with specific biomolecular capture molecules for specific binding of the wanted target and passivated with respect to non-specific interactions, to be then, finally, deposited on surface. This implies that a globular resonator may be basically deposited onto any suitable site on any suitable surface with basically any suitable orientation. In particular, depositing globular resonators, e.g., from colloidal suspension, onto a substrate, e.g., by drop-coating, will result in a random distribution of resonators with random orientation. Random orientation means that there exist at least three different orientations among all possible orientations under which the resonators can be attached to the surface, which show a significant occurrence. The term “orientation” can also be understood in the sense that different regions of the resonator surface are in contact with the substrate surface if they show different orientation. The term “substrate surface” designates a flat surface here, i.e., a surface with a surface roughness or corrugation on a scale much smaller (e.g., one order of magnitude or below) than the resonator dimension. Further, it is assumed here that both resonator surface and substrate surface are homogeneous with respect to their mutual interaction, i.e., different areas of the resonator surface interact with the substrate surface in the same or at least similar fashion, e.g., repulsive or attractive to similar extent.

It should be noted, that this intrinsic and fundamental property of globular resonators that they may be deposited on surface after their preparation does not exclude further or alternative preparation steps after their decoration on surface. For example, it might be wanted to deliver additional or alternative materials to the sensor to, e.g., improve, modify, or optimize its function or to prepare optical contacts with the surface.

In contrast, when two-dimensional resonators, such as above mentioned microdisks, are deposited on surface from colloidal suspension under similar conditions (flat substrate, homogeneous microdisk-substrate interaction), it can be expected that only two different orientations will show a significant occurrence among the deposited resonators. These orientations are obviously “face up” and “face down” with either one of the large disk areas in contact to the substrate. This picture holds at least as long as disk-disk interactions can be neglected, which otherwise might lead to cluster effects that cannot be easily predicted.

Because of these advantages compared to microdisks, passive globular resonators and microresonators have been applied to optical sensing by a number of groups (P. Zijlstra et al., Appl. Phys. Lett. Vol. 90, pp. 161101/1-3, 2007; S. Pang et al. Appl. Phys. Lett. Vol. 92, pp. 221108/1-3, 2008; A. Weller et al., Appl. Phys. B Vol. 90, pp. 561-567, 2008; Vollmer and Arnold, Nature Meth. Vol. 5, pp. 591-596, 2008). Such resonators are either very large in size, i.e., have an extension of their largest dimension of above 50 μm, and thus are not suited for sensing on the micro scale and/or cannot be applied to remote sensing because of their way of evanescent field coupling and/or do not bear any gain medium and/or the gain medium is applied under conditions that do not immediately allow for an operation of the microresonator above the lasing threshold. This can be, for example, if the amount of the gain medium borne is too small or the practically applicable powering of the gain medium is insufficient to promote stimulated emission to an extent that exceeds the losses of the operable optical cavity mode(s). This happens, for example, for small microresonators with sizes (diameters) in the range of some to few tens of micrometers, which exhibit low quality factors and accordingly high losses, which then are difficult to compensate due to the small amount of gain medium that may be borne by such small microresonator.

In fact, lasing in globular microresonators has so far been demonstrated only in air as the ambient, where mostly active microresonators based on dye-doped polystyrene beads (M. Kuwata-Gonokami et al., Jpn. J. Appl. Phys., Vol. 31, pp. L99-101, 1992), rare-metal-doped (V. Lefevre-Seguin, Opt. Mater. Vol. 11, pp. 153-165, 1999) or Raman-emission driven (A. Mazzei et al., Appl. Phys. Lett. Vol. 89, pp. 101105/1-3, 2006) silica spheres, and rare-metal (G. C. Righini et al., Phys. Stat. Solid. A, Vol. 206, pp. 898-903, 2009) or quantum dot-doped (S. Lu et al., Physica E, Vol. 17, pp. 453-455, 2003) glass spheres were applied. For a microresonator in air, because of its refractive index of basically 1, the contrast between cavity material and ambient is optimized, thereby yielding the highest Q-factors achievable with the respective system (e.g., in terms of geometry, size, and materials choice) (P. Zijlstra et al., Appl. Phys. Lett. Vol. 90, pp. 161101/1-3, 2007).

By use of other ambients, such as aqueous solutions, which are of relevance in particular for biochemical sensing, a significant reduction in the optical cavity modes' bandwidth is expected, which is likely to be accompanied with a loss of the ability of the system to surpass the lasing threshold. To account for and address this intricacy of operation of optical cavities or microresonators (globular and in general) in ambients with refractive indices larger than that of air, i.e., —to set a save limit—with refractive indices with values greater than 1.1, such ambients will be called “dense media” in the following. Operation in a dense medium is particularly crucial for resonators with sizes of 50 μm and below, which show typically a significant broadening of their optical cavity modes due to intrinsic losses, such as the increased curvature of the resonator. The inventors of the present invention, however, surprisingly found that active globular microresonators with a nominal size of only 15 μm can still be operated above lasing threshold and employed to optical sensing even under the unfavorable environment of physiological aqueous solutions and even solid biological materials (cf. Example 9). This surprising finding is most likely related to a reduction of the number of excited modes, when microresonators of such small size are immersed into an aqueous phase. Accordingly, the lower number of modes may gain a larger amplification by stimulated emission of the gain medium, because the total power of the latter is distributed among lesser modes. This additional gain may partially compensate the increased losses of the individual optical cavity modes and thus lead to significant light amplification. Even the presence of biomolecules, such as bovine serum albumin (BSA), which—as solute—is known to significantly raise the refractive index of the solution or their encapsulation into the solid phase does not prevent these systems from lasing. Accordingly, the finding of the inventors of the present invention paves the way for a new class of microscopic optical sensors based on microlasers for applications in a variety of sensing applications, such as refractive indices, solute concentrations, mechanical forces, chemical and biochemical reactions, and so forth.

Other important characteristics related to light amplification are long (temporal and spatial) coherence lengths and strong electromagnetic fields. The inventors of the present embodiments found surprisingly that also these effects, which have not been considered in view of their effects on sensing applications of microresonators so far, may add beneficially to the performance of such sensors, in particular for molecular detection, for example by an acceleration of the adsorption kinetics of molecules onto the sensor surface (Example 2). Such acceleration may happen, for example, by a strong polarization of the molecules in vicinity of the microresonator surface induced by the fields of the optical cavity modes. Thus induced dipoles may interact with the oscillating optical fields in an attractive fashion, leading to an attractive force between molecules and sensor surface. This behavior, which has been observed for the first time in Example 2, has recently also been found by Arnold and coworkers in the case of a passive microresonator operated by means of a distributed feedback laser via evanescent field coupling (S. Arnold et al., Opt. Express, Vol. 17, pp. 6230-6238, 2009). The authors explain the interaction between nanoparticles (molecules) and the microresonator by a “carousel trap”, which is driven by “attractive optical gradient forces, interfacial interactions, and the circulating momentum flux”. These effects “considerably enhance the rate of transport to the sensing region, thereby overcoming limitations posed by diffusion on such small area detectors. Resonance frequency fluctuations, caused by the radial Brownian motion of the nanoparticle, reveal the radial trapping potential and the nanoparticle size. Since the attractive forces draw particles to the highest evanescent intensity at the surface, binding steps are found to be uniform.”

Obviously, the same or similar effects cause also the differences in the adsorption kinetics between microresonator operation below and above threshold as shown in FIG. 3 and detailed in Example 2. It must be noted that when Arnold et al. in said article claim a factor of about 100 in acceleration of the binding kinetics by use of a toroidal WGM biosensor, they refer to the results of diffusive and convective transport theory for comparison. In our case, we compare microresonator operation below and above lasing threshold and it cannot be excluded that also the fields induced in the resonator below threshold cause a significant acceleration of the binding kinetics. In this sense, Example 2 demonstrates that operation of a microresonator (optical cavity) above the lasing threshold yields an additional unexpected acceleration of the binding kinetics.

In addition to the acceleration of binding kinetics, radiation-induced effects or events may be related to the interaction of the radiation emitted by the microlaser with its ambient, which may undergo physical, chemical, and/or biochemical changes upon this interaction. For example, a microlaser may be used for local heating, energy deposition, or generation and control of photo-induced reactions and processes, such as photochemical or photobiochemical reactions, formation or release of specific binding between capture molecule and target, materials evaporation, ablation, and plasma formation. Applications of such art are related, for example, to materials processing, micro- and nanotechnology, and the biomedical field, where locally precisely targeted treatments via local exposure of a dense medium (e.g., a biological material) to microlaser radiation may be advantageous in terms of minimized invasiveness and controllability and thus may be an important tool for therapeutic and/or medical treatments, such as minimal invasive surgeries. Such art may be applied to tissue treatment and repair, cancer therapy, controlled drug release, and local stimulation and promotion of biological and biomedical processes. In combination with the potential of the microlaser to bear specific capture molecules, the specificity of these highly localized processes may be further improved and be exploited for targeted therapies.

Another aspect related to the higher intensity of optical cavity modes operated above the lasing threshold (Example 1) is associated with their improved S/N ratio, which allows for a significant reduction of the acquisition times for a single spectrum. Example 4 shows series of WGM spectra obtained at high acquisition rates of 20 and 91 Hz. A further increase of the rate was only limited by the technical limitations of the CCD camera applied. In contrast, acquisition times for spectra of microresonators operated at same average excitation power but below threshold, are in the range of several seconds, i.e. typically about 0.2 Hz with the same acquisition system, to achieve sufficient quality (e.g., in terms of the S/N ratio). Accordingly, operation of optical cavities or microresonators above the lasing threshold opens the way for monitoring fast processes via optical sensing at a high data acquisition rate, which was not possible with these systems before. Arnold and coworkers used evanescent-field coupled passive resonators for optical sensing and achieved data sampling rates, which were also limited only by their detection system. It should be noted that in their case, a tunable laser source is coupled into the passive resonator for sequential scanning of the WGM position. Therefore, according to the Nyquist-Shannon sampling theorem, at least eight data points should be obtained for identification of a single WGM position. In contrast, the microlasers of the present invention collect full spectra over several WGM positions at the given sampling rate. Therefore, even at an about ten-fold lower acquisition rate, the total information content in view of mode positions and bandwidths and the information that can be deduced therefrom is much higher in the case of the microlasers of the present invention. As has been detailed recently by Francois and Himmelhaus (A. Francois, M. Himmelhaus, Sensors Vol. 9, pp. 6836-6852, 2009), when the positions of more than one WGM have been measured, the size of the resonator as well as the refractive index of its ambient can be determined from the data simultaneously, even without reference experiment. This is a great advantage, in particular for remote sensing. For example, for sensing of adsorption layers onto the resonator's surface, the size of the resonator, e.g. in the case of a spherical resonator, its radius, needs to be precisely known, since the wavelength shift corresponding to a certain amount of adsorbate scales inversely with the resonator's dimension (Weller et al., Appl. Phys. B Vol. 90, pp. 561-567, 2008). Therefore, a precise knowledge of the resonator's size will improve the overall reliability of the system. This is particularly important for small resonators with dimensions of 50 μm and below, as they are subject of the present invention. In the case of Arnold and coworkers, remote sensing would not only be hampered by the fact that they typically measure the position of a single WGM only, so that the resonator size cannot be calculated from the mode spacing (FSR), but more severely by their requirement of evanescent field coupling, which violates the idea of a free microscopic resonator as embodied in the present document from a fundamental point of view. The evanescent field coupler, be it an optical fiber, integrated waveguide, focused laser beam, prism, or other suitable object, is a macroscopic device, i.e., physical body, that always exhibits at least one dimension with a size beyond 50 μm in extension. At the same time, the presence of the coupler influences the exact mode positions of the WGMs (Z. Guo et al., J. Phys. D Vol. 39, 5133-5136, 2006; P. Shashanka et al., Opt. Express Vol. 14, pp. 9460-9466, 2006), so that in a sensing process, coupler and resonator have to be seen as a unit. For example, even a small change in the distance between coupler and resonator may cause WGM shifts that are significant in comparison to the measured signal, e.g., for an adsorption layer on the resonator surface. It is therefore not possible for a practical sensing process to consider the resonator without its coupler under the chosen mode of operation. In this sense, resonators (active or passive and of arbitrary size) that are operated via evanescent field coupling by means of a physical coupler are not optical cavities nor microresonators as embodied in the present invention.

In Example 1 it is shown how a microlaser can be operated below or above the lasing threshold by changing the average pump power of the gain medium of the microlaser. This is one option that needs to be applied, for example, when the microlaser is powered with a continuous source. In the case of powering in the form of power pulses, it may be, however, also possible to switch from non-lasing to lasing mode of operation and vice versa by changing the repetition rate of the pulses used for powering. One example of such art is given in Example 5. In that example, powering is achieved by optical pumping of the fluorescent dye embedded into polystyrene microbeads of 15 μm in diameter by means of a picosecond laser source with variable repetition rate. The influence on the average laser output on changes in the repetition rate is minor and also can be adapted to yield the same average output for all repetition rates applied, e.g. by insertion of filters or change of efficiencies (e.g. for the generation of the second harmonic of the laser). With same average output, the pulse energy of a single pulse depends on the repetition rate, which may be a more convenient measure of changing the pump power level to achieve lasing than other means, e.g. for compensation of side effects, such as unwanted scattering of the pump beam or unwanted fluorescence induced by the pump beam, that are dependent on the average intensity of the pump beam and need to be corrected for.

This, however, must be seen only as one example. In other cases, other means of powering may be advantageous, e.g. electrical or electromagnetical, which then may also show a significant dependency of the way of operation on the lasing threshold. In general, the way of powering the microlaser will depend on the case, as will be the way of switching the microlaser(s) from operation below to above threshold and vice versa. It should be noted that temporal operation of the microlaser(s) below threshold might be advantageous, e.g., to increase the lifetime of operation, in alignment or calibration procedures, or, e.g., when using clusters to obtain characteristic fingerprint spectra, as will be detailed in the following.

Another aspect of the present invention involves the utilization of clusters of optical cavities or microresonators for optical sensing. A cluster is a one-, two-, or three-dimensional aggregate of globular resonators that exhibit a superposition of their optical cavity mode spectra. This superposition may be due to optical coupling or other kind of optical mode interaction or come about by the limited spatial resolution of the detection system for recording of the emission of the optical cavities or microresonators within the cluster(s), which then detects more than a single optical cavity or microresonator simultaneously. Earlier we had already found that such clusters exhibit characteristic fingerprint spectra, which are sensitive to changes in the ambient of the cluster(s) as well as to the adsorption of adlayers to same extent as single optical cavities or microresonators, however, with the additional advantage that they can be distinguished by the characteristic lineshape of their spectra, which facilitates parallel operation of a large number of clusters, for example, for multiplexed sensing applications. The inventors of the present invention surprisingly observed that when the clusters consist of microlasers instead of passive optical cavities or microresonators, lasing can be achieved in a number of optical cavity modes that do not necessarily belong to the same cluster. Accordingly, while the spectrum above lasing threshold is typically simpler than that below threshold, i.e., contains a fewer number of lasing optical modes, their positions are still a unique characteristics of the respective cluster, thus maintaining the basic idea of the characteristic fingerprint. The details of these findings are shown in Example 6. Moreover, when changing the excitation of the cluster in such way that only a single microlaser reaches or surpasses the lasing threshold, its lasing optical cavity modes become so strong that all other optical modes from the same or other microlasers within the cluster are basically buried in the background noise (Example 7) and thus, the lasing modes can be utilized to characterize the lasing microlaser individually despite the presence of the others within the cluster. This art may become very useful if clusters of microlasers are prepared, e.g., by drop-coating or spotting techniques, in which a collection of microlasers with different function are present. For example, different microlasers within the cluster may bear different functionalizations to respond to external stimuli in a different fashion. Some microlasers may be rendered passive and serve as a reference signal, while others target the wanted change in the ambient. In biosensing, e.g., different microlasers may bear different kinds of biological capture molecules and then show changes in their optical cavity mode spectra to different extent. Since these changes are typically small, in particular for the formation of (sub-) monolayers on the resonator surfaces, the characteristic lineshape of the fingerprint spectrum is not necessarily distorted but may still be used to identify the cluster. For example, the identification algorithm could account for slight changes in the positions of only some of the cavity modes. Then, a cluster within an assembly of clusters could be identified after a change in their ambient has been applied to the assembly of clusters. Then, the precise information on a certain target could be obtained by operating the different members of the cluster individually above lasing threshold and read-out their corresponding lasing spectra. It should be noted that for identification of the cluster by its fingerprint spectrum, either the spectrum below threshold (i.e., all (most) microlasers of the cluster are operated below threshold) or above threshold (i.e., all (most) microlasers of the cluster are operated above threshold) can be used for their identification. Operation of the cluster below threshold may be beneficial for its lifetime. In general, however, choice of operation will depend on the particular conditions of the respective measurement.

This novel opportunity for the read-out and operation of individual members of a cluster may be further widened by the use of clusters containing microlasers (or optical cavities or microresonators; these terms will be omitted in the following for the sake of brevity but may be substituted or amended wherever suitable) with different or more than a single gain medium. As exemplified in Example 8, it is possible to incorporate two gain media (e.g. fluorescent dyes) into a single microlaser. Then, once the microlaser has become a member of a cluster, it may still be individually addressed by right choice of the excitation source (for examples if all other members of the cluster bear only a single gain medium). In this way, it may also be possible to divide a cluster into two sub-sets, each of which characterized by the gain medium (media) borne by the microlasers within the subset, while still maintaining a characteristic fingerprint. Such fingerprint may resemble parts of the fingerprint spectrum of the whole cluster and thus may serve to determine the fingerprint of a non-measured subset of the cluster. More complex combinations of application of even more gain media and operation below and above threshold of selected microlasers, which may be selected, for example by their gain media, can easily be achieved by those skilled in the art. In view of applications of this art, for example, microlasers bearing different combinations of gain media may bear different specific capture molecules (for example, one kind of microlaser bears one kind of capture molecule). Then, in a cluster of microlasers composed of members of these differently prepared microlasers, signals of different subsets of fingerprint spectra would deliver information about the respective target molecule(s) and thus aid the parallel processing of a variety of sensor signals. This art may be applied to multiplexed biosensing, where the clusters could be prepared, e.g., by application of spotting techniques.

Further, it should be noted that in contrast to related art that has applied assemblies of active microdisks or globular resonators to lasing, in the present invention, the individual microlasers within a cluster may exhibit different size, even to significant extent. Related work focused so far on the fabrication of photonic molecules to achieve mode splitting of coinciding optical cavity modes. Such splitting, however, depends very sensitive on the size distribution of the microlasers involved and thus can be achieved in assemblies of resonators of basically same size. Such mode splitting, however, is not required for the formation of characteristic fingerprint spectra, so that for the purpose of the present invention, such severe size restriction may be relieved.

Also the work of Borchers et al. (M. A. Borchers et al., Opt. Lett. Vol. 26, pp. 346-348, 2001), which does not explicitely state that a photonic molecule is required in their work, report nevertheless that the size of the of the two resonators they used for their experiment was the same (see legend of FIG. 2 of said article). The reason to choose particles of same size in this case is not so much related to mode splitting, but to an efficient near-field coupling between the two resonators, which is required for a significant energy transfer. Thus, also in this particular case, photonic molecules need to be applied.

The most important aspect of the present embodiments is related to the operation of globular microlasers inside of dense media or at least in contact with one of their surfaces in a remotely controlled fashion. Such art is very promising for a plurality of applications in sensing and materials processing right at the wanted location. To demonstrate the feasibility of this approach, Example 9 shows that Nile red-doped 15•m PS beads may be operated under lasing conditions even in protein solutions of very high concentration and inside of solid media, such as gelatin. Operation of the microlasers in high protein solution facilitates their use with body fluids, such as blood and lymph, while gelatin is made from collagen and thus may be viewed as a simple model system for body tissue. Remote-controlled lasing inside of dense media, such as biological materials, for sensing and radiation-induced processing has thus been proven by means of the present embodiments. Thereby, a part or constituent of the dense medium may adsorb to the microlaser, e.g., in the course of a sensing process applying capture molecules.

Finally, it should be noted that the inventors of the present invention are not aware of any work utilizing clusters of microlasers for any kind of optical sensing application.

### Materials Section

The microresonators and/or clusters of optical cavities or microresonators of the present embodiments can be manufactured by using materials, which are available to the public. The following explanations of the materials are provided to help those skilled in the art construct the microresonators and clusters of optical cavities or microresonators in line with the description of the present specification.

Cavity (core) material: Materials that can be chosen for fabrication of the optical cavity (core) are those, which exhibit low absorption in that part of the electromagnetic spectrum, in which the cavity shall be operated. In practice, this is a region of the emission spectrum of the active medium chosen for excitation of the cavity modes. Typical materials are polymer latexes, such as polystyrene, polymethylmethacrylate, polymelamine and the like, and inorganic materials, such different kinds of glasses, silica, titania, salts, semiconductors, and the like. Also core-shell structures and combinations of different materials, such as organic/inorganic or inorganic/organic, organic/organic, and inorganic/inorganic, are feasible. In the case of clusters of optical cavities or microresonators or that more than a single microresonator is used in an experiment, the different optical cavities involved (either constituting the cluster or those of the different single microresonators) may be made from different materials and also may be doped with different active media, e.g., to allow their selective excitation. Also, the cavity (cavities) may consist of heterogeneous materials. In one embodiment, the cavity (cavities) is (are) made from semiconductor quantum well structures, such as InGaP/InGaAlP quantum well structures, which can be simultaneously used as cavity material and as fluorescent material, when pumped with suitable radiation. The typical high refractive index of semiconductor quantum well structures of about 3 and above further facilitates the miniaturization of the cavity or cavities because of the wavelength reduction inside of the semiconductor compared to the corresponding vacuum wavelength. In general, it is advantageous to choose a cavity material of high refractive index, such as a semiconductor, to facilitate miniaturization of the cavity or cavities. It is also possible to choose a photonic crystal as cavity material and to coat either the outer surface of the crystal with a fluorescent material, or to embed the fluorescent material into the crystal in a homogeneous or heterogeneous fashion. A photonic crystal can restrict the number of excitable cavity modes, enforce the population in allowed modes, and define the polarization of the allowed modes. The kind of distribution of the fluorescent material throughout the photonic crystal can further help to excite only the wanted modes, while unwanted modes are suppressed due to improper optical pumping.

An example of photonic crystals including two or three-dimensional non-metallic periodic structures that do not allow the propagation of light within a certain frequency range, the so-called “bandgap” of the photonic crystal, was shown by E. Yablonovitch (Scientific American, Dec. issue, pp. 47-55, 2001). The light is hindered from propagation by distributed Bragg diffraction at the periodic non-metallic structure, which causes destructive interference of the differently scattered photons. If the periodicity of such a photonic crystal is distorted by a point defect, e.g., one missing scattering center in the overall periodic structure, spatially confined allowed optical modes within the bandgap may occur, similar to those localized electronic energy levels occurring within the bandgap of doped semiconductors.

In the present embodiment, the optical cavities shown have a spherical shape. Although such spherical shape is a very useful one, the cavity may in principle have any shape, such as oblate spherical shape, cylindrical, or polygonal shape given that the cavity can support cavity modes, as shown in the related art. The shape may also restrict the excitation of modes into a single or a countable number of planes within the cavity volume.

Active medium: As active medium any kind of material can be used on the condition that the material emits light in the spectral regime of wanted operation of the optical cavity or microresonator and that can be powered (optically, electrically or in any other suitable fashion) in such way that it may induce lasing in said optical cavity or microresonator. If suitable conditions can be found, active media may be utilized as gain media of microlasers. Whether or not such conditions exist, however, may also depend on the chosen way of their powering as well as on the optical cavities and/or microresonators applied, i.e., the entire system under consideration. Such peculiarities, the discussion of which will be omitted in the following, will have to be considered in the respective case of preparing active optical cavities or microresonators. Fluids are known as active media as well as solid state media. Examples of fluids are gases, such as krypton, argon, xenon, nitrogen, CO2, CO, excimers or gas mixtures, such as Helium-Neon or metal vapors, such helium-Cadmium, helium-mercury, helium-selenium, helium-silver, neon-copper, copper vapor, gold vapor. Further examples of fluids are liquids, such as dye solutions or solutions of other kinds of fluorescent materials. Examples of solid state media are Ruby, Nd:YAG, Er:YAG, neodymium YLF, neodymium doped yttrium orthovanadate, neodymium doped yttrium calcium oxoborate, neodymium glass, titanium sapphire, thulium YAG, ytterbium YAG, yttterbium₂O₃, ytterbium doped glass, holmium YAG, cerium doped lithium strontium (or calcium) aluminum fluoride, promethium 147 doped phosphate glass, chromium doped chrysoberyl, erbium doped and erbium ytterbium codoped glass, trivalent uranium doped calcium fluoride, divalent samarium doped calcium fluoride, F-center doped materials. Other kinds of solid state active media are selected from the group consisting of semiconductors and/or semiconductor compounds, such as GaN, AlGaAs, InGaAsP, lead salt, hybrid silicon.

Another example of the active medium are fluorescent materials. As fluorescent material, any type of material can be used on the condition that the material absorbs light at an excitation wavelength λ_{exc}, and re-emits light subsequently at an emission wavelength λₑₘ≠λ_{exc}. Thereby, at least one part of the emission wavelength range(s) should be located within the mode spectrum of the cavity for whose excitation the fluorescent material shall be used. In practice, fluorescent dyes, semiconductor quantum dots, semiconductor quantum well structures, carbon nanotubes (J. Crochet et al., Journal of the American Chemical Society, 129, pp. 8058-9, 2007), Raman emitters, and the like can be utilized. A Raman emitter is a material that uses the absorbed photon energy partially for excitation of internal vibrational modes and re-emits light with a wavelength higher than that of the exciting light. If a vibration is already excited, the emitted light may also have a smaller wavelength than the incoming excitation, thereby quenching the vibration (anti-Stokes emission). In any case, by proper choice of the excitation wavelength many non-metallic materials may show Raman emission, so that also the cavity materials as described above can be used for Raman emission without addition of a particular fluorescent material.

Examples of the fluorescent dyes which can be used in the present embodiments are shown together with their respective peak emission wavelength (unit: nm): PTP (343), DMQ (360), butyl-PBD (363), RDC 360 (360), RDC 360-NEU (355), RDC 370 (370), RDC 376 (376), RDC 388 (388), RDC 389 (389), RDC 390 (390), QUI (390), BBD (378), PBBO (390), Stilbene 3 (428), Coumarin 2 (451), Coumarin 102 (480), RDC 480 (480/470), Coumarin 307 (500), Coumarin 334 (528), Coumarin 153 (544), RDC 550 (550), Rhodamine 6G (580), Rhodamine B (503/610), Rhodamine 101 (620), DCM (655/640), RDC 650 (665), Pyridin 1 (712/695), Pyridin 2 (740/720), Rhodamine 800 (810/798), and Styryl 9 (850/830). All these dyes can be excited in the UV (e.g., at 320 nm) and emit above 320 nm, e.g., around 450 nm, e.g., in order to operate silver-coated microresonators (cf. e.g., WO 2007129682).

However, for microresonators which are not coated with a silver shell, any other dye operating in the UV-NIR regime could be used. Examples of such fluorescent dyes are shown: DMQ, QUI, TBS, DMT, p-Terphenyl, TMQ, BPBD-365, PBD, PPO, p-Quaterphenyl, Exalite 377E, Exalite 392E, Exalite 400E, Exalite 348, Exalite 351, Exalite 360, Exalite 376, Exalite 384, Exalite 389, Exalite 392A, Exalite 398, Exalite 404, Exalite 411, Exalite 416, Exalite 417, Exalite 428, BBO, LD 390, α-NPO, PBBO, DPS, POPOP, Bis-MSB, Stilbene 420, LD 423, LD 425, Carbostyryl 165, Coumarin 440, Coumarin 445, Coumarin 450, Coumarin 456, Coumarin 460, Coumarin 461, LD 466, LD 473, Coumarin 478, Coumarin 480, Coumarin 481, Coumarin 485, Coumarin 487, LD 489, Coumarin 490, LD 490, Coumarin 498, Coumarin 500, Coumarin 503, Coumarin 504 (Coumarin 314), Coumarin 504T (Coumarin 314T), Coumarin 510, Coumarin 515, Coumarin 519, Coumarin 521, Coumarin 521T, Coumarin 522B, Coumarin 523, Coumarin 525, Coumarin 535, Coumarin 540, Coumarin 6, Coumarin 6 laser grade, Coumarin 540A, Coumarin 545, Pyrromethene 546, Pyrromethene 556, Pyrromethene 567, Pyrromethene 567A, Pyrromethene 580, Pyrromethene 597, Pyrromethene 597-8C9, Pyrromethene 605, Pyrromethene 650, Fluorescein 548, Disodium Fluorescein, Fluorol 555, Rhodamine 3B Perchlorate, Rhodamine 560 Chloride, Rhodamine 560 Perchlorate, Rhodamine 575, Rhodamine 19 Perchlorate, Rhodamine 590 Chloride, Rhodamine 590 Tetrafluoroborate, Rhodamine 590 Perchlorate, Rhodamine 610 Chloride, Rhodamine 610 Tetrafluoroborate, Rhodamine 610 Perchlorate, Kiton Red 620, Rhodamine 640 Perchlorate, Sulforhodamine 640, DODC Iodide, DCM, DCM Special, LD 688, LDS 698, LDS 720, LDS 722, LDS 730, LDS 750, LDS 751, LDS 759, LDS 765, LDS 798, LDS 821, LDS 867, Styryl 15, LDS 925, LDS 950, Phenoxazone 660, Cresyl Violet 670 Perchlorate, Nile Blue 690 Perchlorate, Nile red, LD 690 Perchlorate, LD 700 Perchlorate, Oxazine 720 Perchlorate, Oxazine 725 Perchlorate, HIDC Iodide, Oxazine 750 Perchlorate, LD 800, DOTC Iodide, DOTC Perchlorate, HITC Perchlorate, HITC Iodide, DTTC Iodide, IR-144, IR-125, IR-143, IR-140, IR-26, DNTPC Perchlorate, DNDTPC Perchlorate, DNXTPC Perchlorate, DMOTC, PTP, Butyl-PBD, Exalite 398, RDC 387, BiBuQ Stilbene 3, Coumarin 120, Coumarin 47, Coumarin 102, Coumarin 307, Coumarin 152, Coumarin 153, Fluorescein 27, Rhodamine 6G, Rhodamine B, Sulforhodamine B, DCM/Pyridine 1, RDC 650, Pyridine 1, Pyridine 2, Styryl 7, Styryl 8, Styryl 9, Alexa Fluor 350 Dye, Alexa Fluor 405 Dye, Alexa Fluor 430 Dye, Alexa Fluor 488 Dye, Alexa Fluor 500 and Alexa Fluor 514 Dyes, Alexa Fluor 532 Dye, Alexa Fluor 546 Dye, Alexa Fluor 555 Dye, Alexa Fluor 568 Dye, Alexa Fluor 594 Dye, Alexa Fluor 610 Dye, Alexa Fluor 633 Dye, Alexa Fluor 647 Dye, Alexa Fluor 660 Dye, Alexa Fluor 680 Dye, Alexa Fluor 700 Dye, and Alexa Fluor 750 Dye.

Combinations of different dyes may be used, for example with at least partially overlapping emission and excitation regimes, for example to widen, tailor or shift the operation wavelength regime(s) of the optical cavities or microresonator(s) (and/or microlasers).

Water-insoluble dyes, such as most laser dyes, are particularly useful for use with the optical cavities, microresonators, or microlasers, while water-soluble dyes, such as the dyes obtainable from Invitrogen (Invitrogen Corp., Carlsbad, Calif.), are particularly useful for staining of their environment.

Semiconductor quantum dots that can be used as fluorescent materials for doping the microresonators have been described by Woggon and coworkers (M. V. Artemyev & U. Woggon, Applied Physics Letters 76, pp. 1353-1355, 2000; M. V. Artemyev et al., Nano Letters 1, pp. 309-314, 2001). Thereby, quantum dots (CdSe, CdSe/ZnS, CdS, CdTe for example) can be applied to the present embodiments in a similar manner as described by Kuwata-Gonokami and co-workers (M. Kuwata-Gonokami et al., Jpn. J. Appl. Phys. Vol. 31, pp. L99-L101, 1992), who have shown that the fluorescence emission of dye molecules can be utilized for population of microresonator cavity modes. The major advantage of quantum dots over dye molecules is their higher stability against degradation, such as bleaching. The same argument holds for semiconductor quantum well structures, e.g., made from InGaP/InGaAlP, which exhibit high stability against bleaching and cannot only be used as fluorescent material but also as cavity material. Also semiconductors in other forms, such as particulates, films, coatings, and/or shells (W. Fang et al., Appl. Phys. Lett., Vol. 85, pp. 3666-3668, 2004) may be applied as active or gain media

The excitation wavelength λ_{exc} of the fluorescent material does not have necessarily to be smaller than its emission wavelength λₑₘ, i.e., λ_{exc}<λₑₘ, since one also can imagine multiphoton processes, where two or more photons of a given energy have to be absorbed by the material before a photon of twice or higher energy will be emitted. Processes of this kind can be two-photon (or multiple photon) absorption or nonlinear optical processes, such as second-harmonic, third-harmonic, or higher-harmonic generation. Also, as mentioned above, Raman anti-Stokes processes might be used for similar purpose.

Combinations of different fluorescent materials, such as those exemplified above, may be used, for example to widen, tailor or shift the operation wavelength regime(s) of the optical cavity (cavities) or microresonator(s). This may be achieved, for example, by suitable combination of excitation and emission wavelength regimes of the different fluorescent materials applied. In general, the fluorescent material may be incorporated into the cavity material, be borne by the optical cavity's surface, and/or be borne by the optional shell of the optical cavity, and/or brought into its ambient, such as a biological material or a dense medium in general. The distribution can be used to select the type of cavity modes that are excited. For example, if the fluorescent material is concentrated in vicinity of the surface of a suitable optical cavity, whispering gallery modes are more likely to be excited than Fabry Perot modes. If the fluorescent material is concentrated in the center of the optical cavity, Fabry Perot modes are easier to excite (A. Weller & M. Himmelhaus, Appl. Phys. Lett., Vol. 89, pp. 241105/1-3, 2006). Other examples of a heterogeneous distribution are those, in which the fluorescent material is distributed in an ordered fashion, i.e., in terms of regular two- or three-dimensional patterns of volumes with a high concentration of the fluorescent material. In such a case, diffraction effects may occur, which help to excite the cavity in distinct directions, polarizations, and/or modes, e.g., similar to those found in distributed feedback dye lasers.

Shell: The optical cavities and/or the clusters of optical cavities or microresonators might be embedded in a shell, which might have a homogeneous thickness and/or composition or not. The shell may consist of any material (metal, dielectric, semiconductor) that shows sufficient transmission at the excitation wavelength λ_{exc} of the chosen one or more active media. Also, the shell may consist of different materials with wanted properties, for example to render the surface of microresonator(s) and/or cluster(s) of microresonators transparent only at wanted locations and/or areas, to bear the one or more active media, or—to give another example—to facilitate selective (bio-)functionalization. For example, when applying semiconductors as shell materials, the shell becomes transparent when the excitation wavelength is higher than the wavelength corresponding to the bandgap of the considered semiconductor. For a metal, high transparency may be achieved, for example, by taking advantage of the plasma frequency of the metal, above which the conduction electrons of the metal typically do no longer contribute to the absorption of electromagnetic radiation. Among useful metals are aluminum and transition metals, such as silver, gold, titanium, chromium, cobalt and the like. The shell can be continuous, as fabricated for example via evaporation or sputtering, or contiguous as often achieved by means of colloidal metal particle deposition and subsequent electroless plating (Braun & Natan, Langmuir 14, pp. 726-728, 1998; Ji et al., Advanced Materials 13, pp. 1253-1256, 2001; Kaltenpoth et al., Advanced Materials 15, pp. 1113-1118, 2003). Also, the thickness of the shell may vary from few nanometers to several hundreds of nanometers. The only stringent requirement is that the reflectivity of the shell is sufficiently high in the wanted spectral range to allow for Q-factors with values of Q>1. For FPM in spherical cavities, the Q-factor can be calculated from the reflectance of the shell 4 (or vice versa) by the formula

$$Q = \frac{{λ}_{m}}{{Δλ}_{m}} = m π \frac{\sqrt{{R}_{sh}}}{1 - {R}_{sh}} , \qquad ( 5 )$$

where Rₛₕ is the reflectance of the shell and λₘ the wavelength of cavity mode m.

Biofunctional coating: The microresonator(s) or clusters of optical cavities or microresonators may be coated with a (bio-)functional coating facilitating their (bio-) mechanical and/or (bio-) chemical function. For example, they may be functionalized with specific analytes to initiate a wanted response of a cell, tissue, and/or biological material in general, or to facilitate biomechanical and/or biochemical sensing, e.g., by application of capture molecules, which are able to specifically bind their targets. For sake of brevity, the microresonators or clusters of microresonators will be called “the sensor” in the following.

To render the sensor selective for specific analytes, it is preferred to coat the sensor surface with coupling agents that are capable of (preferably reversibly) binding an analyte, such as proteins, peptides, and nucleic acids. Methods for conjugating coupling agents are well-known to those skilled in the art for various kinds of surfaces, such as polymers, inorganic materials (e.g., silica, glass, titania) and metal surfaces, and are equally suitable for derivatizing the sensor surface of the present embodiments. For example, in the case of a transition metal-coating (e.g., gold, silver, copper, and/or an alloy and/or composition thereof), the sensor of the present embodiments can be chemically modified by using thiol chemistries. For example, the metal-coated non-metallic cores can be suspended in a solution of thiol molecules having an amino group such as aminoethanethiol so as to modify the sensor surface with an amino group. Next, biotin modified with N-hydroxysuccinimide suspended in a buffer solution of pH 7-9 can be activated by EDC, and added to the sensor suspension previously modified by an amino group. As a result, an amide bond is formed so as to modify the metal-coated non-metallic cores with biotin. Next, avidin or streptavidin comprising four binding sites can be bound to the biotin. Next, any biotin-derivatized biological molecule such as protein, peptide, DNA or any other ligand can be bound to the surface of the avidin-modified metal-coated non-metallic cores.

Alternatively, amino-terminated surfaces may be reacted with an aqueous glutardialdehyde solution. After washing the sensor suspension with water, it is exposed to an aqueous solution of proteins or peptides, facilitating covalent coupling of the biomolecules via their amino groups (R. Dahint et al., Anal. Chem., 1994, 66, 2888-2892). If the sensor is first carboxy-terminated, e.g., by exposure to an ethanolic solution of mercaptoundecanoic acid, the terminal functional groups can be activated with an aqueous solution of EDC and N-hydroxysuccinimide. Finally, proteins or peptides are covalently linked to the activated surface via their amino groups from aqueous solution (Herrwerth et al., Langmuir 2003, 19, 1880-1887).

In a similar fashion, also non-metallic sensors can be specifically functionalized. For example, polyelectrolytes (PE), such as PSS, PAA, and PAH, can be used as described in the literature (G. Decher, Science Vol. 277, pp. 1232ff., 1997; M. Losche et al., Macromol. Vol. 31, pp. 8893ff., 1998) to achieve a sensor surface comprising a high density of chemical functionalities, such as amino (PAH) or carboxylic (PAA) groups (this technique is also applicable to metal-coated sensors). Then, for example the same coupling chemistries as described above can be applied to these PE coated sensors. Alternatively, and in analogy to the thiol chemistry described above for functionalization of metal surfaces, suitable kinds of coupling agents, such as amino-, mercapto-, hydroxy-, or carboxy-terminated siloxanes, phosphates, amines, carboxylic or hydroxamic acids, and the like, can be utilized for chemical functionalization of the sensor surface, on which basis then coupling of biomolecules can be achieved as described in the examples above. Suitable surface chemistries can be found in the literature (e.g., A. Ulman, Chem. Rev. Vol. 96, pp. 1533-1554, 1996).

A general problem in controlling and identifying biospecific interactions at surfaces and particles is non-specific adsorption. Common techniques to overcome this obstacle are based on exposing the functionalized surfaces to other, strongly adhering biomolecules in order to block non-specific adsorption sites (e.g., to BSA). However, the efficiency of this approach depends on the biological system under study and exchange processes may occur between dissolved and surface bound species. Moreover, the removal of non-specifically adsorbed biomolecules may require copious washing steps, thus, preventing the identification of specific binding events with low affinity.

A solution to this problem is the integration of the coupling agents into inert materials, such as coatings of poly- (PEG) and oligo(ethylene glycol) (OEG). The most common technique to integrate biospecific recognition elements into OEG-terminated coatings is based on co-adsorption from binary solutions, composed of protein resistant EG molecules and a second, functionalized molecular species suitable for coupling agent coupling (or containing the coupling agent itself). Alternatively, also direct coupling of coupling agent to surface-grafted end-functionalized PEG molecules has been reported.

Recently, a COOH-functionalized polyethylene glycol) alkanethiol has been synthesized, which forms densely-packed monolayers on gold surfaces. After covalent coupling of biospecific capture molecules, the coatings effectively suppress non-specific interactions while exhibiting high specific recognition (Herrwerth et al., Langmuir 2003, 19, pp. 1880-1887).

The binding entities immobilized at the surface may be proteins such as antibodies, (oligo-)peptides, oligonucleotides and/or DNA segments (which hybridize to a specific target oligonucleotide or DNA, e.g., a specific sequence range of a gene, which may contain a single nucleotide polymorphism (SNP), or carbohydrates). To reduce non-specific interactions, the binding entities will preferably be integrated in inert matrix materials.

Capture molecules: Molecules for capturing specific targets may be any molecules with affinity to the wanted target. In particular, proteins, such as antibodies, and related specifically binding biomolecules may be applied as well as nucleotides, peptide sequences and related systems known to those skilled in the art.

Position control functionality: The sensors of the present embodiments may be utilized as remote sensors and therefore may require control of their positions and/or movements by external means, for example to control their contact and/or interaction with a selected ambient, e.g. dense medium. Such control may be achieved by different means. For instance, the sensors may be rendered magnetic and magnetic or electromagnetic forces may be applied to direct the sensor(s) (C. Liu et al., Appl. Phys. Lett. Vol. 90, pp. 184109/1-3, 2007). For example, paramagnetic and super-paramagnetic polymer latex particles containing magnetic materials, such as iron compounds, are commercially available from different sources (e.g., DynaBeads, Invitrogen Corp., or BioMag/ProMag microspheres, Polysciences, Warrington, Pa.). Because the magnetic material is embedded into a polymeric matrix material, which is typically made of polystyrene, such particles may be utilized in the same or a similar way as optical cavity mode sensors as the non-magnetic PS beads described in the examples below. Alternatively or in addition, a magnetic material/functionality may be borne by the shell of the microresonator(s) and/or their (bio-)functional coating.

Further, the position control may be mediated by means of optical tweezers (J. R. Moffitt et al., Annu. Rev. Biochem. Vol. 77, pp. 205-228, 2008). In such case, the laser wavelength(s) of the optical tweezers may be either chosen such that it does or that it does not coincide with excitation and/or emission wavelength range(s) of the fluorescent material(s) used to operate the sensor. For example, it might be desirable to use the optical tweezers' operating wavelength also for (selective) excitation of (one of) the fluorescent material(s). One advantage of optical tweezers over magnetic tweezers would be that a number of different sensors may be controlled individually at the same time (C. Mio et al., Rev. Sci. Instr. Vol. 71, pp. 2196-2200, 2000).

In other schemes, position and/or motion of the sensors may be controlled by acoustic waves (M. K. Tan et al., Lab Chip Vol. 7, pp. 618-625, 2007), (di)electrophoresis (S. S. Dukhin and B. V. Derjaguin, “Electrokinetic Phenomena”, John Wiley & Sons, New York, 1974; H. Morgan and N. Green, “AC Electrokinetics: colloids and nanoparticles”, Research Studies Press, Baldock, 2003; H. A. Pohl, J. Appl. Phys. Vol. 22, pp. 869-671, 1951), electrowetting (Y. Zhao and S. Cho, Lab Chip Vol. 6, pp. 137-144, 2006), and/or by a microfluidics device that potentially may also be capable of sorting/picking particles and/or cells of desired dimension and/or function (S. Hardt, F. Schönfeld, eds., “Microfluidic Technologies for Miniaturized Analysis Systems”, Springer, New York, 2007).

Also mechanical tweezers may be utilized for position control of the sensor(s), for example by employing a microcapillary capable of fixing and releasing a particle via application of pressure differences (M. Herant et al., J. Cell Sci. Vol. 118, pp. 1789-1797, 2005). The beauty of this approach is that for example in cell sensing experiments, sensors and cells may be manipulated using the same instrumentation (cf. M. Herant et al.). Also combinations of two or more of the schemes described above may be suitable for position control of sensor(s) and/or cell(s) or other kinds of dense media.

Excitation of optical cavity modes: The gain media that may be applied to microlaser operation may be powered electrically, electromagnetically, and/or optically. While electrical powering, e.g., of microlasers or clusters of microlasers based on semiconductor technology, seems convenient, e.g., in terms of minimization of the excitation system in view of size and required components, radiation-controlled powering, such as optical excitation, of the gain media seems advantageous in particular with regard to remote operation of the microlasers and/or clusters thereof. For such radiation-controlled excitation, a radiation (light) source may be suitably chosen such that its emission at least partially overlaps with the excitation frequency range ω_{exc} of one or more active media. In the case of utilization of multiphoton processes, such as multiple photon absorption or harmonic generation, for excitation of the one or more active media, the emission frequency range of the light source may be chosen suitably in such way that the emission of the wanted multiphoton process falls into (or partially overlaps with) the excitation frequency range •_{exc} of the one or more active media. The emission power should be such that it can overcompensate the losses (radiation losses, damping, absorption, scattering) that may occur in the course of excitation of the microresonators. Irrespective of the excitation scheme, preferred light sources are thermal sources, such as tungsten and mercury lamps, and non-thermal sources, such as gas lasers, solid-state lasers, laser diodes, DFB lasers, and light emitting diodes (LEDs). Lasers or high power light emitting diodes with their narrower emission profiles will be preferably applied to minimize heating of sample and environment. For same purpose, also short and ultrashort pulsed light sources may be exploited. The latter may also allow for pump-and-probe experiments or for lock-in techniques for optical cavity mode detection and analysis. Such short-pulsed light sources may be any of above mentioned light sources but now with a temporally modulated emission intensity profile, such as pulsed thermal lamps, pulsed LEDs or laser diodes, or pulsed lasers. Further, pulsed sources may be advantageously utilized to achieve lasing in microresonators or clusters of optical cavities or microresonators, because even at low average power of the light source, the peak power (intensity) within a pulse may exceed the lasing threshold (see, e.g., A. Francois & M. Himmelhaus, Appl. Phys. Lett. Vol. 94, pp. 031101/1-3, 2009).

Broadband light sources with a spectral emission over several nanometers or more may be particularly useful for evanescent field coupling to the microresonator(s) via a focused light beam (see e.g., Oraevsky, Quant. Electron. Vol. 32, pp. 377-400, 2002). In such case, the broad spectrum of the source may allow for simultaneous excitation of more than a single optical cavity mode of the respective microresonator(s). Such broadband sources may also be pulsed sources and can be combined, for example, with lock-in detection of optical cavity modes.

If several active media are utilized with properly chosen, e.g., non-overlapping, excitation frequency ranges, more than a single light source or a single light source with switchable emission wavelength range may be chosen such that individual microresonators or clusters of optical cavities or microresonators may be addressed selectively, e.g., to further facilitate the readout process or for the purpose of reference measurements. Further, the excitation power of at least one of the light sources may be chosen such that (under the respective conditions) at least one of the microresonator(s) or clusters of optical cavities or microresonators utilized is/are operated—at least temporally—above the lasing threshold of at least one of the optical cavity modes excited. Finally, it should be noted that for coupling of the excitation radiation any kind of suitable coupling optics may be utilized, such as free-beam coupling, evanescent field coupling via a focused beam, a waveguide, prism, near-field probe, or other kind of optical coupler. In particular, far-field and near field optics may be applied and combined. Also, the coupling optics may be the same as that utilized for analysis of optical cavity modes or apply same methods and techniques.

Analysis of optical cavity modes: For the collection of radiation scattered from optical cavity modes any kind of suitable collection optics known to those skilled in the art may be utilized. For example, the emission can be collected by a microscope objective of suitable numerical aperture and/or any other kind of suitable far-field optics, by an optical fiber, a waveguide structure, an integrated optics device, the aperture of a near field optical microscope (SNOM), or any suitable combination thereof. In particular, the collection optics may utilize far-field and/or near-field collection of the signal, e.g., by applying evansecent field coupling. Then, the collected light can be analyzed by any kind of suitable spectroscopic apparatus applying dispersive and/or interferometric elements or a combination thereof. For the sake of brevity, the entire system for analysis of optical cavity modes, including the light collection optics and the spectroscopic apparatus, will be called “detection system” in the following and may bear also other suitable parts, such as optical, optomechanical, and/or optoelectronic in nature. The most important feature of the detection system is to allow the determination of the wanted property (-ies) of the optical cavity modes, such as their frequencies, bandwidths, directions and kinds of propagation, polarizations, field strengths, phases, and/or intensities, or changes thereof at a precision, which is sufficient for the respective purpose(s). In the case of parallel processing of more than one microresonator or cluster of optical cavities or microresonators also more than one detection system may be utilized. Alternatively, a detection system able to process more than the emission of a single microresonator or cluster of optical cavities or microresonators simultaneously or in (fast) series may be applied. For example, confocal fluorescence microscopes combine fluorescence excitation via laser light with collection of the fluorescence emission with high numerical aperture, followed by filtering and spectral analysis of the fluorescence emission. Since such instruments are often used in cell studies, they may provide a convenient tool for implementation of the present embodiments. Other convenient instruments are, for example, Raman microscopes, which also combine laser excitation and high numerical aperture collection of light signals from microscopic sources with spectral analysis. Further, both kinds of instruments allow simultaneous spectral analysis and imaging, which facilitates tracing of the microresonator during its mission. If such imaging information is not required, also other kinds of devices, such as fluorescence plate readers, may be applicable.

### EMBODIMENTS

### Embodiment 1

### Microlaser for Remote Optical Sensing

A microlaser is at least partially disposed into a dense medium, where it is utilized for optical sensing of any suitable kind of physical, chemical, and/or biochemical condition of the medium or changes thereof by means of analysis of optical cavity modes. The microlaser may freely float, be moved by external forces (such as magnetic or optical tweezers) or rest at a target position. The kind of movement (free, forced, or resting) may alter in the course of time. Powering of the microlaser is achieved by any kind of suitable optical, electrical, or electromagnetical pumping, whereby the microlaser may be operated below and above its lasing threshold. Analysis of optical cavity modes is typically achieved by collection of some of the optical or electromagnetic radiation scattered from the microlaser and subsequent analysis by means of a suitable detection system. The timing of this analysis can be freely chosen and may change in the course of time.

### Embodiment 2

### Multiple Microlasers for Remote Optical Sensing

A plurality of microlasers are at least partially disposed into a dense medium, where they are utilized for optical sensing of any suitable kind of physical, chemical, and/or biochemical condition of the medium or changes thereof by means of analysis of optical cavity modes. The microlasers may freely float, be moved by external forces (such as magnetic or optical tweezers) or rest at a target position. Different microlasers may move or rest by different mechanisms, which further may change in the course of time. Powering of the microlasers is achieved by any kind of suitable optical, electrical, or electromagnetical pumping, whereby the microlasers may be operated below and above their respective lasing thresholds. Thereby, some microlasers may be operated above the lasing threshold, others below threshold, and further this condition may change in the course of time. Analysis of optical cavity modes is typically achieved by collection of some of the optical or electromagnetic radiation scattered from the microlasers and subsequent analysis by means of a suitable detection system, which may process the plurality of microlasers either in a parallel or in a serial fashion. Also, a plurality of detection systems is applicable. The timing of the analysis of the microlasers' optical cavity modes can be freely chosen, may be different for different microlasers, and may change in the course of time.

### Embodiment 3

### Cluster of Microlasers for Remote Optical Sensing

A cluster forms out of a plurality of microlasers either before, during, or after the cluster and/or the microlasers are at least partially disposed into a dense medium. Before, during, or after cluster formation, the cluster and/or the single microlasers are utilized for optical sensing of any suitable kind of physical, chemical, and/or biochemical condition of the medium or changes thereof by means of analysis of optical cavity modes. The cluster and the microlasers may freely float, be moved by external forces (such as magnetic or optical tweezers) or rest at a target position. The cluster and the different microlasers may move or rest by different mechanisms, which further may change in the course of time. Powering of the cluster and the microlasers is achieved by any kind of suitable optical, electrical, or electromagnetical pumping, whereby the cluster and microlasers may be operated below and above their respective lasing thresholds. Thereby, the cluster may be operated below or above threshold in a freely chosen fashion. Also, some microlasers may be operated above the lasing threshold, others below threshold, and further this condition may change in the course of time. Analysis of optical cavity modes is typically achieved by collection of some of the optical or electromagnetic radiation scattered from the cluster and/or the microlasers and subsequent analysis by means of a suitable detection system, which may process the cluster and the plurality of microlasers either in a parallel or in a serial fashion. Also, a plurality of detection systems is applicable. The timing of the analysis of the cluster's and microlasers' optical cavity modes can be freely chosen, may be different for the cluster and the different microlasers, and may change in the course of time.

### Embodiment 4

### Single Microlasers and Clusters of Microlasers for Remote Optical Sensing

According to embodiments 1-3, a plurality of microlasers and clusters of microlasers may be at least partially disposed into a dense medium, whereby the timing of the disposal may be freely chosen and clusters may form before, during, or after the (partial) disposal of the constituting microlasers into the medium. The microlasers and clusters of microlasers may be utilized for optical sensing of any suitable kind of physical, chemical, and/or biochemical condition of the medium or changes thereof by means of analysis of optical cavity modes. The modes of their operation are analogous to those detailed in embodiments 1-3.

### Embodiment 5

### Microlaser for Optical Sensing of Molecules

A microlaser is at least partially disposed into a medium, where it is utilized for optical sensing of molecules. The operation of the microlaser is the same as already given in embodiment 1. A part of the surface or other suitable region (e.g., the shell or the core) of the microlaser may be prepared for reception of the molecule (e.g. by application of capture molecules), which may then be sensed by analysis of optical cavity modes. Thereby, the microlaser may be operated—at least temporally—above the lasing threshold to achieve an acceleration of the sensing process or to induce another kind of suited radiation-induced process. The method of this embodiment for sensing the microlaser by analysis of optical cavity modes is also applicable to Embodiments 2-4, i.e., for sensing of molecules using a plurality of microlasers, and clusters of microlasers and any suitable combination thereof.

### Embodiment 6

### Microlaser for Optical Sensing on a Surface

A microlaser brought into contact with at least one surface of a dense medium, where it is utilized for optical sensing of any suitable kind of physical, chemical, and/or biochemical condition of the medium or changes thereof by means of analysis of optical cavity modes. The microlaser may temporally also freely float or be moved by external forces (such as magnetic or optical tweezers), when it does not rest at its target position, for example for collection of target molecules. The kind of movement (free, forced, or resting) may alter in the course of time. Powering of the microlaser is achieved by any kind of suitable optical, electrical, or electromagnetical pumping, whereby the microlaser may be operated below and above its lasing threshold. Analysis of optical cavity modes is typically achieved by collection of some of the optical or electromagnetic radiation scattered from the microlaser and subsequent analysis by means of a suitable detection system. The timing of this analysis can be freely chosen and may change in the course of time.

### WORKING EXAMPLES

### Example 1

### Determination of the Lasing Threshold of Nile Red-Doped PS Beads

FIG. 2 shows examples of optical set-ups for excitation and detection of optical cavity modes in microcavities. In FIG. 2(I), excitation and detection are pursued through separated light paths. Namely, a fluorescent microresonator 1 coated with an optional coating 2 is disposed on a substrate 3. The fluorescent microresonator 1 with the optional coating 2 is located in a microfluidic flow environment 4. A light source 5 emits an excitation light beam 6 to the fluorescent microresonator 1. The fluorescence emission 15 excited by the light beam 6 is collected by a lens 7 and transmitted through an optical fiber 8 via an optical filter 9 to a monochromator and photodetector (e.g., CCD) 10. In FIG. 2(II), the same lens 7 is used for excitation and detection of the cavity modes. Namely, the light beam 6 from the light source 5 is reflected by a beam splitter 11 and emitted to the fluorescent microresonator 1 via the lens 7. The fluorescence emission 15 excited by the light beam 6 is collected to the same lens 7 and guided to the photodetector 10 through the beam splitter 11 and a mirror-guided detection path 12 (In FIG. 2 (II), the fluorescence emission 15 of the microresonator 1 is indicated only in the directions most relevant to detection, neglecting contributions from scattering and/or reflection). These two schemes are only examples. Alternative schemes that replace for example free-beam guidance via mirrors with optical fibers or other kinds of waveguides or that replace the collection lens 7 by a fiber-optical collection device or a near-field probe for detection of the fluorescence emission 15 are also feasible and can be easily achieved by those with average skills in the art. Independent of the scheme of observation of cavity modes, the microresonator(s) studied can be fixed, e.g., surface-attached, in the flow cell or freely floating, e.g., in the liquid medium. Also internalization into objects present in the flow cell is feasible. For example, the internalization of the microresonator(s) into a biological cell can be achieved by disposing at least a part of microresonator(s) into the cell; before, during, or after disposing the part of the microresonator(s) into the cell, applying a fluorescent material to the microresonator(s) and/or to the cell to optically label the microresonator(s) and/or the cell; and sensing the process of the cell by optical observation of the fluorescent material in interaction with the microresonator(s). The details of this method are disclosed in the U.S. provisional patent application No. 61/111,369, which is incorporated by reference as mentioned above.

The lasing threshold of nile red-doped 15 μm PS beads in aqueous environment has been determined as follows. For excitation of the optical cavity modes, an optical set-up as sketched in FIG. 2(II) was applied, i.e., excitation and detection of the cavity modes was achieved by using the same lens (collection optics) 7.

### Experimental

Sensor fabrication: Sulfonated polystyrene microbeads with a nominal size of 15 μm were purchased from Polysciences, Inc. (Warrington, Pa.). The beads were doped with nile red by a protocol similar to that given in the literature (cf., e.g., A. Weller et al., Appl. Phys. B Vol. 90, pp. 561-567, 2008). Materials used in the protocol are: aqueous suspension of polymer (polystyrene) beads (250 μl), water-insoluble dye, xylene (2000 μl), millipore water (8 ml), glass vial (20 ml), centrifuge vial (2 ml), and closable glass vial for 100 deg Celsius operation. The beads were prepared under the protocol as follows: 1) dissolving dye in xylene, until saturation limit is reached, 2) placing 8 ml of Millipore water and 250 μl of the bead suspension into a 20 ml glass vial, 3) putting a stirring magnet into the solution, placing vial onto a stirrer, and adjusting speed to 350-400 rpm (solution should appear homogeneous), 4) gently adding 2 mL of the saturated dye solution and stirring the resulting two-phase system until xylene has evaporated, and optionally heating the vial to speed up the evaporation process, 5) once xylene is evaporated, removing the thin film of dye that may have formed on the surface of the bead solution, and then, pipetting the beads and putting them into a glass vial that can be hermetically sealed, 6) putting vial into an oven at 100 deg Celsius for about 2 hours, until beads have sunken to the bottom of the vial, to remove residual xylene from the beads (beads containing too much xylene will still remain at the surface of the suspension and can therefore be separated easily), and 7) pipetting beads and washing them several times by centrifuging recovered aqueous suspension (typically 5-7000 rpm, RT down to 10 deg Celsius, 10-15 min; parameters depending on bead size; with larger particles (above 1 μm) slower speed and lower temperature preferable), removing the supernatant, and replacing the removed liquid volume with Millipore water (a small centrifugation vial of few mL volume is sufficient for these washing steps, because bead suspension has already been pipetted twice).

A diluted suspension of the doped particles was then dispersed on a UV-ozone cleaned glass cover slip and allowed to dry to yield a random 2D distribution of particles, including aggregates (“clusters”). Particles and surface were then coated with several bilayers of PE to fix the particles in position. Then, a PDMS molded microfluidic channel was put on top of the glass to yield a sealed microfluidic channel system.

Optics: For excitation and detection of optical cavity modes, an inverted Nikon microscope (TS100) equipped with a 100× oil-immersion objective was applied. As excitation light source, a frequency-doubled Nd:YAG laser with variable repetition rate and a single pulse duration of 9 ps was used (Rapid, Lumera Laser GmbH, Kaiserslautern, Germany). Unless otherwise stated, the system was operated at a repetition rate of 10 kHz. The average power was measured by means of a laser powermeter (Fieldmate with PS10 power sensor, Coherent Inc., Santa Clara, Calif.). The detection was mediated by coupling the camera port of the microscope to a high-resolution monochromator (Triax 550, Horiba Jobin Yvon, Japan) equipped with 300 L/mm, 600 L/mm, and 2400 L/mm gratings. A CCD camera (DU440, Andor Technology, Belfast, Northern Ireland) was mounted to the camera port of the monochromator and digitized spectra were recorded by means of a personal computer. For protection of the optics, the fundamental laser line was filtered by utilization of a 532 nm laser line filter at the laser exit port and a suitable color filter cutting the 532 nm excitation positioned at the camera port of the microscope.

Determination of lasing threshold: The microfluidic flow channel was mounted to the microscope and the channel was filled with PBS buffer solution. Then, a suitable bead or a cluster of beads was selected and brought into the focus of the lens (detection optics) 7. The excitation laser was aligned such that excitation was at an optimum for optimum fluorescence detection. Subsequently, the laser power was varied and the respective emission spectra recorded. The values given below represent the laser power emitted by the microscope objective 7. Reflection losses and the cross-sectional differences between beam diameter and sphere size (typically smaller than the beam diameter) are neglected, thus the values show safe upper limits for the threshold. Typical camera and detection settings: full vertical binning, 1 s acquisition time; slit width at monochromator entrance 40 μm.

Results: FIG. 3 displays WGM spectra of anile red-doped 15 μm PS bead at excitation below the lasing threshold (FIG. 3(a)) and above the lasing threshold ((FIG. 3(b)), respectively. The spectra show untreated raw data and were recorded subsequently within few minutes under identical conditions with respect to alignment, excitation and detection settings, except for the repetition rate of the picosecond laser pulses used for excitation of the WGM. In FIG. 3(a), the laser was operated in quasi-continuous mode at a pulse repetition rate of 500 kHz, in FIG. 3(b) in pulsed mode at a rate of 10 kHz. The average power was kept constant at about 30 μW, yielding ˜60 pJ per laser pulse in the case of FIGS. 3(a) and ˜3 nJ per laser pulse in the case of FIG. 3(b). It should be noted that due to the special design of the laser, the change in the repetition rate does hardly influence neither beam profile nor pulse duration (e.g., fundamental at 1064 nm: 8.4 ps at 500 kHz and 9.1 ps at 10 kHz).

Below the lasing threshold, a sequence of almost equally spaced WGM spectra on top of a broad fluorescence background is discernible. Above the lasing threshold, a few very strong and narrow lines dominate the spectrum. The fluorescent background has dropped to about 30% of its magnitude below the lasing threshold (see the inset of FIG. 3(b)), indicating that most of the fluorescence intensity is now emitted into the lasing modes. The significant improvement of the signal-to-noise ratio for operation above the lasing threshold is clearly discernible. It should be noted that the acquisition time for both spectra was only 0.011 s, indicating that high temporal resolution is achievable for sensing by means of this technique.

To get a clue on the onset of lasing, the excitation power was varied at a constant pulse repetition rate of 10 kHz. For each spectrum, the dominant lasing mode was selected and fitted by means of Voigt profiles to account for homogeneous and inhomogeneous broadening. As a measure of peak intensity, the integrated peak areas of the corresponding peaks are displayed in FIG. 4. In FIG. 4, the average over four different experiments is shown, and the error bars indicate the Gauss-propagated errors of the standard deviations of the areas as given by the fitting routine.

The evolution of peak intensity with excitation power exhibits clearly two different linear regimes, one with lower slope up to about 0.025 mW and second one with higher slope above that value. Linear fitting of these two regimes as indicated in FIG. 4 and equating the two resulting linear equations yields a lasing threshold of 32 μW as marked in FIG. 4 by the point of intersection of the two linear fits.

The inset of FIG. 4 shows a wider range of measurements. At very high excitation power, the peak intensity falls off from the linear behavior because of too fast bleaching of the dye. Therefore, for determination of the lasing threshold, the data displayed in the main figure of FIG. 4 has been evaluated.

The onset of lasing is typically accompanied by a narrowing of the bandwidth of the corresponding mode and therefore, in turn, by an increase of the mode's quality factor. That this is in fact the case—or more accurate—that the observed changes in the spectra are in fact caused by the onset of lasing, can be seen from the evolution of the bandwidth with increasing excitation power as shown in FIG. 5. Below 30 the FWHM widths of the modes are about 0.45 nm and drop sharply to about 0.12 nm above that value, where they remain almost independent of the further increase of the excitation power (FIG. 5(a)). Accordingly, the quality factors of the modes increase from about 1500 below the lasing threshold to about 5000 above. As pointed out in the literature (cf. S. Arnold et al., Opt. Lett. Vol. 28, pp. 272-274, 2003 Y. Lin et al., Proc. SPIE Intl. Soc. Opt. Eng. Vol. 6452, pp. 64520U/1-8, 2007), a high quality factor is vital for the detection limit of a WGM resonator when used for optical sensing, so that operating the microresonator above the lasing threshold gives an improvement of the sensitivity limit of more than a factor of three.

The following Examples 2-9 were performed using the same experimental equipment as described above.

### Example 2

### Monitoring BSA Adsorption by WGM Sensors Operated Below and Above the Lasing Threshold, Respectively

To elucidate the expected improvement of sensitivity and performance in optical sensing when operating an optical microresonator above the lasing threshold, the following study on BSA adsorption onto the bead surface was performed.

Nile red-doped PS beads as studied in Example 1 were placed into a micro-fluidic channel fabricated from PDMS and then exposed to a constant flow of PBS buffer. After proving that the WGM positions were stable, the flow was changed to a PBS buffer solution containing 0.01% of BSA. The change of the WGM mode positions in response to BSA adsorption onto the bead surface was then monitored in-situ and in real-time.

Experimental: Sensor fabrication, excitation and detection were performed as in the example above. 0.01% BSA solution in PBS was flown through the microfluidic flow cell at a constant flow rate of 33.75 μL/min. The excitation laser was set to a fixed repetition rate of 10 kHz and operated at a power either below (15 μW) or above (55 μW) the lasing threshold. The acquisition time for the spectra was set to 5 s for measurements below threshold and to 0.1 s above threshold, single accumulation. As a reference for the measured adsorption kinetics, the experiment was also performed by means of a surface plasmon resonance (SPR) apparatus (Biocore X, Biacore Japan, Tokyo, Japan) using a PSS-terminated gold chip and a flow rate yielding the same mass flow as that used in the WGM experiments. The SPR apparatus performs data collection in 2 s intervals.

Results: The results of the BSA adsorption experiment are shown in FIG. 6, which compares the kinetics obtained for (i) a bead operated below the lasing threshold at 15 μW excitation power (open squares), (ii) one operated above the threshold at 55 μW (open circles), and (iii) a reference kinetics as obtained from a SPR measurement on a gold surface coated with the same sequence of PE layers as the two PS beads studied. Due to different channel cross-sections, the SPR flow rate was set such that the same volume flux was achieved as in the WGM experiments. The acquisition times for an individual spectrum were set to 0.1 s for WGM spectra above and to 5 s for those below threshold. Despite of this difference of a factor of 50, the kinetics below threshold exhibits high noise, while that above threshold shows a very smooth evolution with negligible noise comparable to the signal quality of SPR, which performs data collection in 2 s intervals. One should keep in mind, however, that the SPR instrument samples over a macroscopic surface area of about 0.4 mm², while the sensor senses an over 500 times smaller area, which also may explain the noise in the measurement below threshold.

Obviously, the kinetics above threshold is much faster than the two other ones. The cause of this difference has not been revealed yet, but might originate either from thermal effects or is related to the higher field strength in vicinity of the PS bead, which might polarize the molecules and cause their motion towards the bead surface. In any case, as long as the biomolecular function of the molecules is not affected by such effects, an acceleration of an otherwise diffusion-controlled adsorption may be desirable, in particular for biomedical diagnostics applications. Therefore, we will study these effects in more detail in the future.

Further, during the initial adsorption phase, both the WGM kinetics obtained below and above the lasing threshold show a delayed growth in comparison to SPR, as can be seen from the inset of FIG. 3. While the latter resembles basically a Langmuir adsorption kinetics (k_{ads}=(0.0124±5 10⁻⁵) 1/s), the slower response in the case of the WGM sensors indicates a gradual change in BSA concentration, which might have its origin in the use of macroscopic valves and tubing for the WGM experiments.

Despite of such open questions, the measurements clearly reveal the improvement of the performance of low-Q WGM biosensors in view of S/N ratio, speed of acquisition, and detection limit.

### Example 3

### Lasing in Liquid

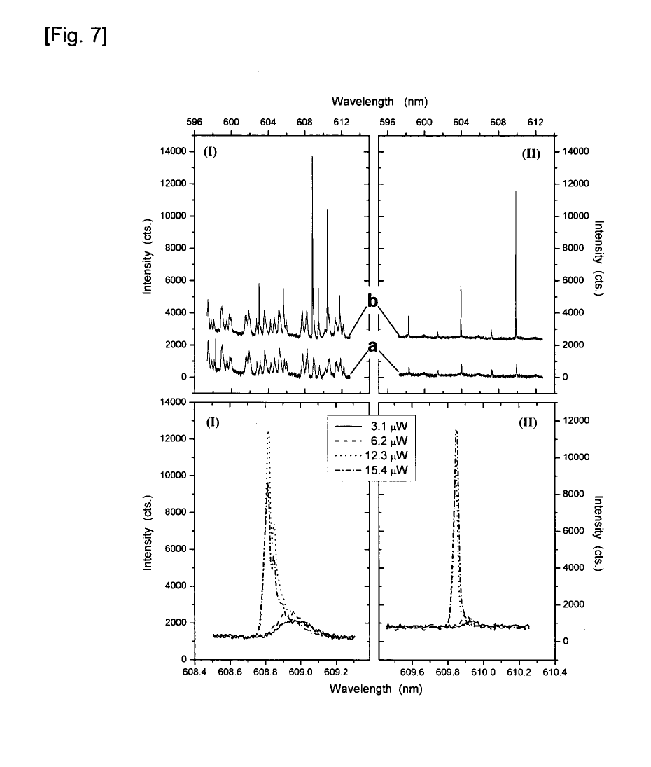

Lasing in microcavities has been achieved already in related art (M. Kuwata-Gonkami & K. Takeda, Opt. Mater. Vol 9, pp. 12-17, 1998), but not in liquid. FIG. 7 shows the result of comparison of lasing in air with lasing in water. In air, as can be found in the literature, the cavity mode spectra look rather complex, because cavity modes of different order are excited (see FIG. 7 upper (I)). In contrast, in water, only the lowest order modes are excited, which give well-separated and very narrow bands (see FIG. 7 upper (II)). This is advantageous for the operation of the microlaser, because (i) the total emission power is shared between fewer modes, thus facilitating reaching of the lasing threshold for an individual mode; (ii) there is no overlap between neighboring modes, facilitating the detection of peak shifts, which is important for sensing applications. As an example of the latter, FIG. 7 lower (I)(II) show blowups of small peak regions of FIG. 7 upper (I)(II) for a number of excitation powers. It can be seen that in the dry state two closely located modes start lasing, thereby making the determination of their positions more difficult. On the right hand side, only a single mode is seen, thus facilitating (sensing) applications.

### Example 4

### Fast Acquisition

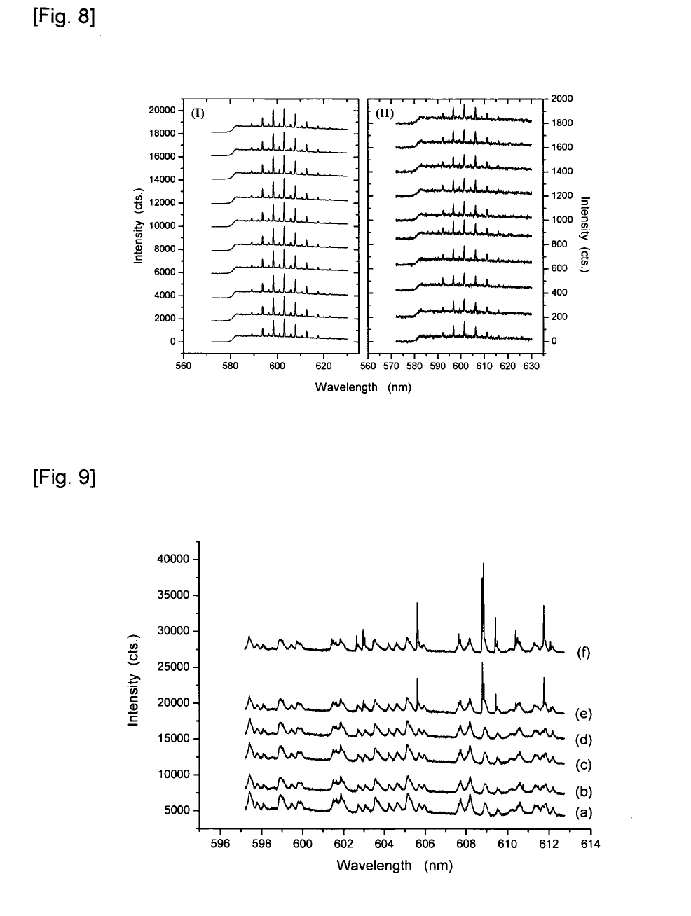

Another important feature of lasing is the higher intensity of the modes, i.e., their higher emission power (which can be seen also from FIGS. 3 and 7 when comparing non-lasing and lasing). Because of this high power, high-speed acquisition of WGM in liquid environment becomes feasible. FIG. 8 shows the results of fast acquisition experiment on 15 μm PS beads in water showing a sequence of 10 spectra acquired subsequently at 0.05 s per frame (in FIG. 8(I)) and at the maximum speed of the CCD camera of 0.011 s per frame (in FIG. 8(II)). Pulse repetition rate 10 kHz, average power leaving the microscope objective 46 μW (spectra are taken subsequently from bottom to top). As shown in FIG. 8, the CCD camera can be operated at its fastest acquisition speed, which is about 10 ms, and still useful spectra can be acquired. This was not possible without lasing because of the much lower signal-to-noise ratio. Therefore, operating a cavity mode sensor above the lasing threshold allows for high speed real-time monitoring, which was not feasible before.

### Example 5

### Dependency of the Lasing Threshold on the Pulse Repetition Rate

For achieving lasing, one typically applies a pulsed laser for excitation of the dye incorporated into the PS bead. A 532 nm Nd:YAG laser with a single pulse duration of 9 ps and variable repetition rate was used. The repetition rate, i.e., the pulse sequence (sequence of pulses with 9 ps duration each) can be varied from 500 kHz to 10 kHz and below. FIG. 9 shows the dependency of the lasing threshold on the repetition rate of the laser used for excitation of WGM lasing in a 15 μm PS bead placed on a microscope cover slip in air. In FIG. 9, all spectra were acquired at an average power of 9.2 μW, but at pulse repetition rates of 500 kHz (FIG. 9(a)), 200 kHz (FIG. 9(b)), 100 kHz (FIG. 9(c)), 50 kHz (FIG. 9(d)), 20 kHz (FIG. 9(e)), and 15 kHz (FIG. 9(f)). Obviously, the lasing threshold is reached only for the two lowest repetition rates of 20 kHz and 15 kHz, indicating that only in these cases the pulse energy of the individual laser pulses is sufficiently high to overcome the lasing threshold of the bead under the given experimental conditions. Thus, by simply switching the repetition rate of the pump laser while leaving all other parameters of the experiment constant, the microcavities may be easily switched from non-lasing to lasing condition and vice versa.

### Example 6

### Clusters of Microresonators Operated in the Stimulated Emission Regime

In the examples above, individual fluorescent microresonators, which were not in (optical) contact to others, were studied and operated below and above the lasing threshold. In the following examples, we will describe the impact of using clusters of microresonators instead of isolated ones.

Experimental: PS beads with a nominal diameter of 15 μm were doped with Nile red and deposited onto a glass cover slip in aqueous environment. The microresonators and clusters thereof were excited by means of the 2^{nd} harmonic of a Nd:YAG picosecond laser with variable repetition rate (10-500 kHz) and a pulse duration of 9 ps. The laser emission was coupled into the inverted microscope via a built-in fluorescence filter block, such that microresonator excitation and detection were mediated through the same microscope objective (Nikon 100×). The pulse energy could be either varied by rotating a lambda half plate in front of the nonlinear optical crystal used for 2^{nd} harmonic generation, or simply by varying the repetition rate of the laser pulses, while keeping the average power constant. For detection, the same system was applied as in the examples above (Horiba Jobin Yvon Triax 550 equipped with an Andor cooled CCD camera).

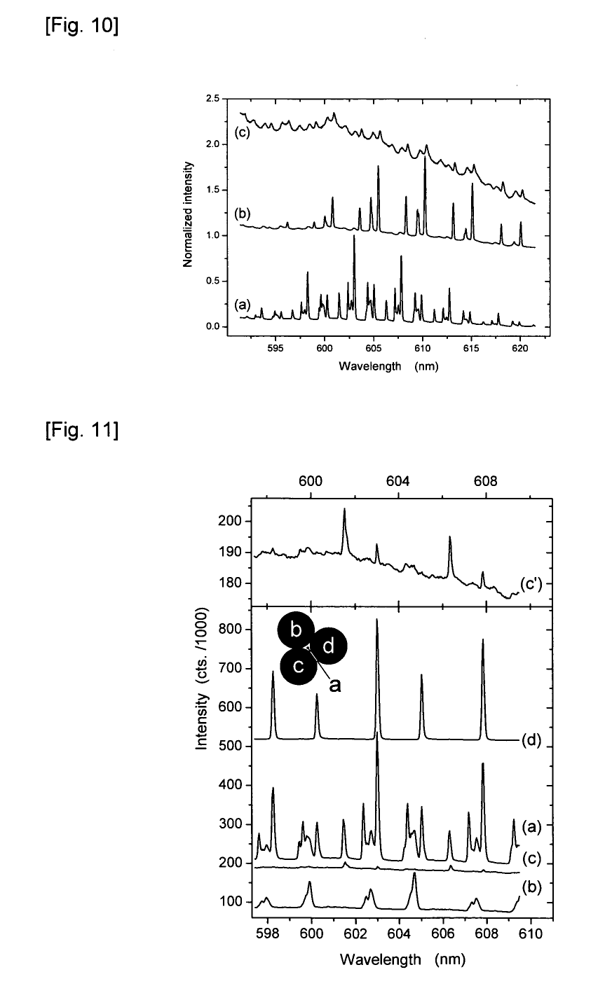

Results: FIG. 10 displays WGM spectra obtained from two different trimers of 15 μm PS beads, both forming triangles of basically equal side length (cf. sketch in FIG. 11), excited above and below the lasing threshold. WGM spectrum (c), which was acquired below the lasing threshold, resembles the fingerprint lineshape as found in the examples above. When this trimer is pumped above threshold (spectrum (b)), the lineshape changes drastically, because not all WGM reach the lasing threshold under the same conditions and with same efficiency. Besides a change in the relative intensities, in particular a smaller number of modes is observable in spectrum (b). Nevertheless, comparing the two spectra shows that all modes observable in spectrum (b) can be related to peaks in the WGM spectrum below threshold (c). It should be noted that the “missing” peaks are still present in spectrum (b), however, they are “buried” in the background due to their much lower intensity as compared to the lasing modes (the spectra of FIG. 10 were normalized to their respective maximum intensity to facilitate the comparison of mode positions and general lineshape and normalized to vertically displaced for clarity).

Because of these obvious differences in the lineshape below and above threshold, respectively, the most important question for the present embodiment is whether—despite of the smaller number of modes—the fingerprint characteristics of the spectra may be preserved also in the stimulated emission regime. That this the case, is exemplified by spectrum (a), which was obtained under lasing conditions from the second trimer. Due to the size distribution of the PS beads, the different lasing modes appear at different positions as compared to spectrum (b). Also, the lineshape is different due to the presence of additional modes. This indicates that sensors based on clusters of microresonators may be operated above the lasing threshold without losing their individual—though somewhat altered—fingerprint, while taking advantage of the much better signal-to-noise ratio and the smaller linewidth of the lasing modes (cf a prior U.S. provisional patent application No. 61/112,410 which was filed on Nov. 7, 2008). In particular the smaller linewidth further improves the sensitivity of the sensor, because even smaller wavelength shifts may be resolved with narrower modes.

### Example 7

### Selective Analysis of Microresonators within a Cluster by Selective Lasing

This example further explores the potential of operating clusters of microresonators above the lasing threshold. Due to the significant difference in emission intensity between lasing and non-lasing modes, individual microresonators within a cluster can be analyzed in view of their WGM spectra independently, if they can be separately operated above the lasing threshold. In such case, the fingerprint spectrum emerging from other, non-lasing members of the cluster, is simply buried in the background as illustrated in the example above (FIG. 10).

FIG. 11 exemplifies this procedure (experimental details same as in Example 6). As illustrated by the sketch in the FIG. 11, the trimer was excited in different ways by focusing the laser beam onto different regions. The diameter of the beam focus was about 30 μm and thus about twice the nominal particle diameter, however, with an about four-fold higher intensity in the beam center, which allowed selective pumping of individual microresonators within the trimer above the lasing threshold. Spectrum (a) was acquired by aligning the beam center into the center of the trimer, thus pumping all three beads above threshold. Spectra (b)-(d) were then obtained by aligning the beam center onto the different beads as indicated in the sketch. Spectra (b) and (d) clearly show lasing of the respective beads, while spectrum (c) is below threshold. It should be noted that FIG. 11 shows non-normalized raw data as acquired with the CCD camera (0.1 s acquisition time accumulated over 10 acquisitions) for direct comparison of the different WGM intensities achieved. Because of its low intensity, a blow-up of spectrum (c) is shown in the upper half of FIG. 11 (c′). Spectra (b)-(d) all show the characteristics of WGM obtained from individual beads in water (cf. FIG. 3a, and, e.g., P. Zijlstra et al., Appl. Phys. Lett. Vol. 90, pp. 161101/1-3, 2007; S. Pang et al. Appl. Phys. Lett. Vol. 92, pp. 221108/1-3, 2008) and thus allow for the individual analysis of the selected bead. At the same time, however, the cluster exhibits a characteristic fingerprint spectrum, thereby facilitating its identification (cf. an U.S. provisional patent application No. 61/018,144 filed on Dec. 31, 2007, a PCT application No. PCT/JP2007/059443 filed on Apr. 26, 2007, and an U.S. provisional patent application No. 61/111,369 filed on Nov. 5, 2008). In combination of these two effects, an individual microresonator on surface can be addressed by first identifying its host cluster by its characteristic fingerprint spectrum (by excitation above threshold of all (most) members of the cluster), followed by a selective excitation above threshold of the wanted bead only. It should be noted that due to the typically small number of microresonators within one cluster (typically 2-8), the individual microresonators within the cluster may be distinguished by their single particle spectra due to their size variation, which makes it very unlikely to have two particles of identical size (within the resolution of the detection system) out of thousands of particles in suspension within the same cluster. This way of addressing individual microresonators within a cluster may be of interest, for example, when bead radii and/or other parameters, such as the refractive index of the ambient and/or the characteristics of the adsorbate, need to be precisely determined. In such case, the slight differences in the WGM mode shifts due to different microresonator size and different mode polarizations (TE, TM) may be precisely measured and used for a more sophisticated analysis of the measurement. Also, in the case that different microresonators within the same cluster bear different functionalization, e.g., for targeting different (bio-)molecules or bearing a passivation layer for reference purpose, individual read-out of microresonators within a cluster may be wanted. In such case, the basic idea of fingerprint spectra may be maintained for small differences in the wavelength shifts of the individual microresonators comprising the cluster or by the analysis of fingerprint spectra of subsets of microresonators of the cluster. In the latter case, subset spectra may be also numerically overlapped in such way that the overall fingerprint is maintained (e.g., by correcting the wavelength axis according to the individual wavelength shifts measured for the different subsets and subsequent numerical superposition of the corrected subset spectra).

### Example 8

### Selective Analysis of Microresonators within a Cluster Applying More than One Fluorescent Material

In the above example, selective analysis of microresonators within a cluster was achieved by taking advantage of the significant differences in mode intensity above and below the lasing threshold, respectively. More generally, such significant difference in mode intensity may be achieved by utilization of different excitation schemes for the different members of a cluster. In the present examples, which apply dye-doped PS beads, such different excitation scheme may be achieved easily by doping the particles with different fluorescent dyes and by utilization of excitation light sources with suitable excitation wavelengths allowing selective dye excitation. The emission wavelength ranges of such differently doped particles may be overlapping or non-overlapping, depending on the application. Overlapping emission wavelength ranges provide the option of generating fingerprint spectra in the overlap region as discussed in the example above and therefore may find preferred application, e.g., in multiplexing applications and the like (cf a prior U.S. provisional patent applications No. 61/018,144 which was filed on Dec. 31, 2008). Also, they may facilitate the detection set-up, because the same settings can be used for the detection of signals from all kinds of microresonators applied. In the following, it will be shown that this alternative scheme for selective microresonator excitation can be beneficially combined with the scheme based on selective excitation of microresonators above the lasing threshold.

Experimental: To obtain PS beads with different excitation but overlapping emission wavelength regimes, 15 μm PS beads were doped with a mixture of C6G and Nile red. As shown in Examples 1 and 2, C6G can be excited at 442 nm, while Nile red does hardly absorb in this regime. C6G emits in the range from 490-550 nm, which is basically the range of Nile red excitation. Therefore, a bead that contains both dyes, can be excited either at 442 nm via the C6G, the emission of which will excite the Nile red present in the bead, or at 532 nm, where the Nile red is directly pumped. In both cases, the emission wavelength range is from about 580 nm to 650 nm and thus basically matches the emission wavelength range of PS beads solely doped with Nile red.

For particle excitation, the HeCd laser operated at 442 nm and the Nd:YAG picosecond laser operated at 532 nm were applied as in the examples above. Because different optical set-ups were used for beam guidance of the two laser beams (HeCd laser from top of the sample as illustrated in FIG. 5 and Nd:YAG laser through the microscope objective), the clusters could be effortlessly exposed to both beams simultaneously and/or to one of the beams only.

The samples (clusters of PS beads) were prepared by dispersing a mixture of 15 μm PS beads in water, some of which doped with C6G and Nile red, some of which doped with Nile red only, onto a cleaned microscope cover slip. Clusters were selected for analysis by verifying that only some beads within a cluster could be effectively excited by means of the 442 nm radiation, while others could be not. Such a “mixed” cluster will be studied in the following.

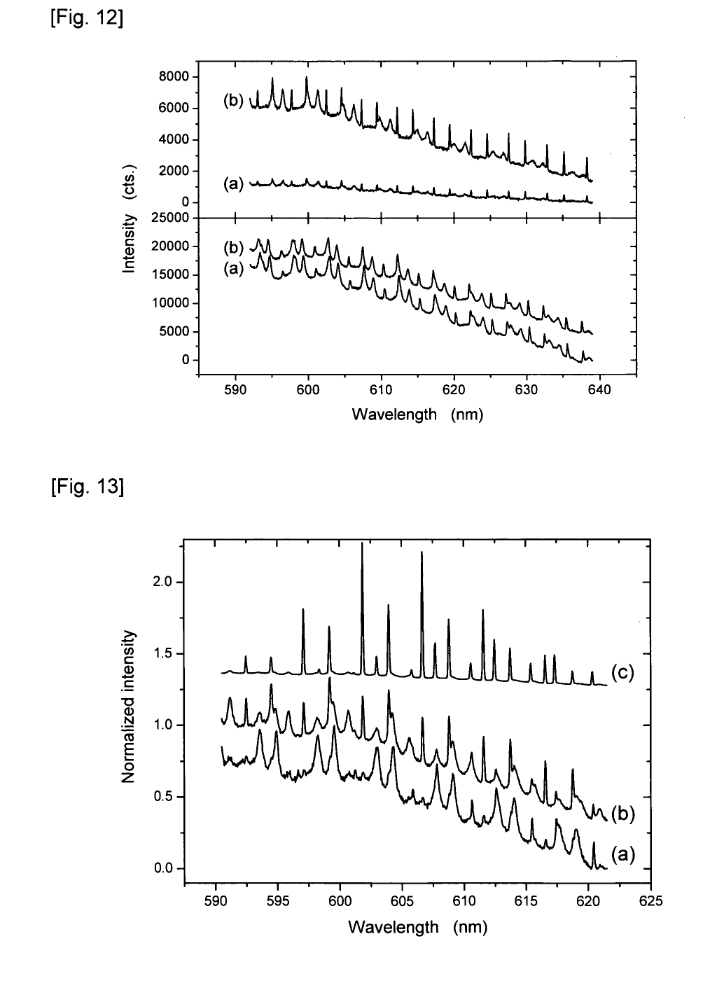

Results: In a first step it was verified that the two kinds of beads used (doped with Nile red only: “Type I”; doped with C6G AND Nile red: “Type II”) in fact achieved different emission intensity in the overlapping emission wavelength regime. This was verified by exposing single microresonators of the two kinds to the two different excitation sources. FIG. 12 displays typical results. In the upper half a single PS bead of Type I is exposed to the 442 nm radiation (a) and to the 532 nm radiation (b), respectively. Obviously, the 532 nm radiation is much more effective in exciting WGM. It should be noted that the spectra of FIG. 12 show non-normalized raw data as obtained from the CCD camera for direct comparison of their WGM intensities (spectra (b) were slightly displaced for clarity). Also, the laser intensities were set such that they achieved WGM spectra of similar strength. Because the HeCd laser is a cw laser of moderate output power, lasing could not be achieved. Therefore, also the picosecond Nd:YAG laser was operated below threshold.

In the lower half of FIG. 12, the spectra obtained from a Type II bead are shown for excitation with the 442 nm radiation (a) and the 532 nm radiation (b), respectively. Because of the presence of C6G in this bead, the Nile red can be effectively excited through the C6G emission, so that the WGM spectra obtained from the bead are basically independent of the source of excitation.

Accordingly, fingerprint spectra of clusters may be obtained by excitation of the cluster at 532 nm, where all beads utilized can be effectively excited, while individual beads (Type II only) can be addressed by using the 442 nm radiation.

As a demonstration of this principle, FIG. 13 shows normalized spectra obtained from a mixed dimer (one bead of Type I and one bead of Type II) excited with the 442 nm radiation (a) and the 532 nm radiation (b), respectively. In spectrum (a), despite of some minor contributions from other modes (possibly originating from the Type I bead), the first order TM/TE pairs characteristic for single beads in aqueous environment (cf. FIG. 3a and, e.g., P. Zijlstra et al., Appl. Phys. Lett. Vol. 90, pp. 161101/1-3, 2007; S. Pang et al. Appl. Phys. Lett. Vol. 92, pp. 221108/1-3, 2008) can be clearly identified and thus used for analysis of the Type II bead. Information about the Type I bead may then be obtained for example by subtracting spectrum (a) from spectrum (b). Here, however, we make use of the different emission characteristics of the excitation lasers for accessing information about the Type I bead. As shown in spectrum (c), the pump intensity of the 532 nm radiation was raised above the lasing threshold, thus yielding a lasing spectrum of the Type I bead only (cf. Examples 6 and 7). Again, the spectrum exhibits the characteristic TM/TE pairing, this time however showing the WGM of the Type I bead solely (all other non-lasing modes buried in the background as discussed in the examples above). The reason why only the Type I bead is lasing is related to the observation that in the batch of particles used, the C6G/Nile red doped beads exhibited a somewhat broader bandwidth and accordingly lower Q-factor than the beads doped with Nile red only (cf. FIG. 12). While the reason for this difference is presently unclear, it may be used for selective lasing of the Type I bead, because in general, modes with the highest Q-factors show the lowest lasing thresholds. Therefore, by proper choice of the pump intensity, lasing of only the Type I bead could be achieved.

The latter procedure shows that the different schemes for selective excitation (use of different fluorescent dyes and lasing, respectively) may be also combined to yield information about individual microresonators within a cluster and that individual spectra may be obtained below and above the lasing threshold, depending on the scheme utilized for their excitation.

The applications for the procedures presented in this example are basically the same as discussed at the end of Example 7, i.e., are related to an improved analysis and to the application of differently functionalized microresonators within a cluster.

### Example 9

### Microlasers in Dense Media

This experiment was designed as a proof of the applicability of the microlasers of the present embodiments as freely floating microlasers in dense media. As examples for dense media, we selected 10% BSA/PBS solution and solidified gelatin as model systems for highly concentrated protein solutions and solid biological materials, such as tissue, respectively. Experimental: The WGM sensors, i.e., Nile red-doped 15•m PS beads, the laser for excitation, and the detection system were the same as in the examples above. The monochromator was utilized with the 600 L/mm grating, 10•m entrance slit width. Exposure time settings of the CCD camera were 0.1 s for spectra above and 1 s for spectra below threshold, respectively. The average power of the 532 nm picosecond radiation at the microscope objective (100×) was 51•W at 10 kHz and 53•W at 500 kHz. The Nikon inverted microscope was switched between a 40× and a 100× microscope for changing the power density on the microbead under study. To prove that the selected microbead was not located at the surface of the sample but in the volume of the dense medium under study, a microscope objective with low magnification was first focused on upper and lower boundary of the medium (e.g. onto the glass cover slip bearing the medium) and then slowly tuned through the volume. Thereby, beads located in the inner volume of the respective material were identified. Gelatin was obtained from BD Difco, BSA 10% solution in PBS was obtained from MP biochemicals. The BSA solution was used as received, the gelatin was mixed with deionized water (at 3 wt % and 5 wt %), stirred, heated to 45 deg Celsius for 30 min, then mixed with the bead suspension (15•L bead suspension/1985•I water), poured into the lids of Falcon 1.5″ PS petri dishes, and solidified at 4 deg Celsius. After solidification, the petri dishes were place upside down onto the stage of the inverted microscope, beads in the inner volume selected and studied.

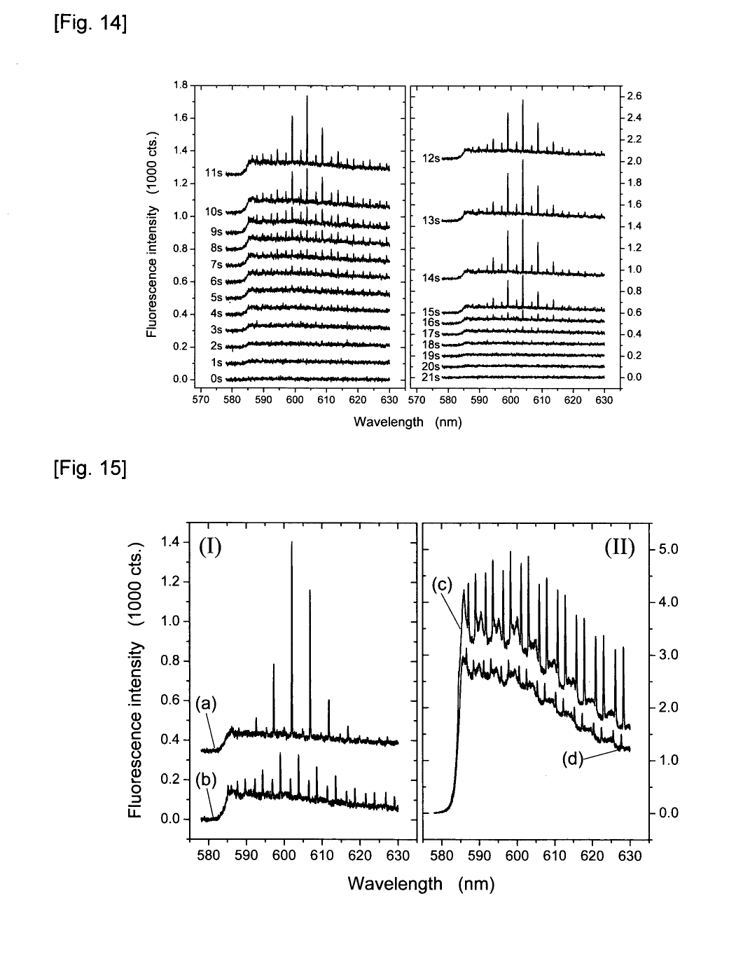

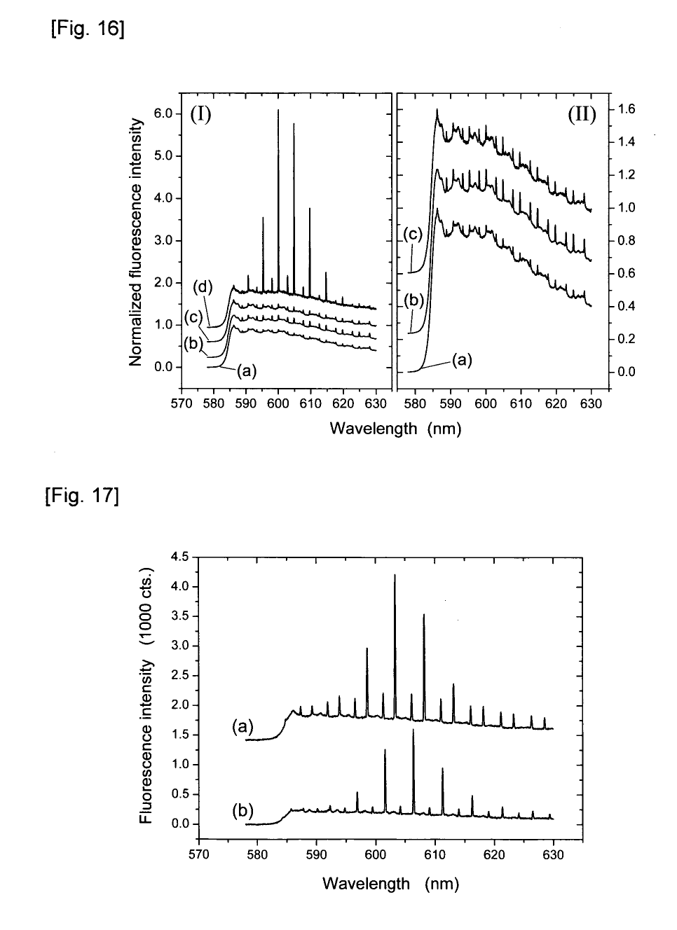

Results: As a first proof of the operability of freely floating microlasers in dense media, FIG. 14 shows a series of WGM spectra obtained from a microbead freely floating in 10% BSA solution, thereby crossing the focus of the 40× objective. Spectra were obtained in real time in time intervals of 1 s (0.1 s acquisition time). The laser was set to 10 kHz repetition rate to allow operation of the microbead above lasing threshold if in the center of the focus of the microscope objective. As becomes evident from the figure, WGM are excited first below threshold, then, while the bead is passing through the focus, also above threshold (as evident from the Gaussian intensity distribution of lasing modes, cf. FIG. 3). Then, the bead leaves the excitation area of the laser radiation and the fluorescence signal disappears. That the bead was positioned in the inner volume had been determined by the method outlined above before start experiment and was once more confirmed right after termination of the experiment. Thus, it is proven that the microbeads used as globular microlasers of the present embodiments may in fact be applied as freely floating remote-controlled microlasers that may be utilized for optical sensing by means of analysis of their optical cavity modes (WGM in the present case). These intrinsically remotely operable systems may also be operated when adsorbed to a surface, as shown in FIG. 15, which compares WGM spectra above (I) and below (II) lasing threshold of freely floating (a, c) and surface-adsorbed (b, d) microlasers immersed in 10% BSA/PBS solution. To switch between operation above and below threshold, the repetition rate of the excitation laser was changed (10 kHz for operation above, 500 kHz for operation below threshold). The spectra shown are typical representatives of the respective case. Typically, surface-adsorbed microlasers show higher lasing thresholds, some of them did not show lasing under the chosen conditions at all. However, as illustrated in FIG. 16, an increase of the power density on the microlaser by switching from the 40× objective to the 100× objective, lasing may be achieved also in these beads. This is a proof of the a priori assumption that surface-adsorbed microlasers experience higher losses due to surface interactions and thus are more difficult to operate. Surprisingly, however, the Q-factors of some of the first order WGMs are still sufficiently high to allow lasing at sufficiently high excitation power. In detail, WGM spectrum (c) of FIG. 16 shows a spectrum obtained at 10 kHz with the 40× objective, i.e., under the conditions shown in FIG. 15. Obviously, the bead is not lasing as can be seen from the comparison with the spectra obtained at 500 kHz (40× objective (a), 100× objective (b)). However, when switching at 10 kHz repetition rate to the 100× objective, the bead starts lasing, as can be concluded from the Gaussian intensity distribution of the modes. This demonstrates that the globular microlasers of the present embodiments may be used freely floating in a dense medium as well as in contact to at least one of its surfaces.

Another important and unexpected result is related to the operation of globular microlasers in solid media. As a first demonstration of this potential, Nile red-doped 15•m PS microbeads were embedded in gelatin with a solid content of 3 and 5 wt % respectively. Beads in the inner volume of the gelatin were identified as detailed above. FIG. 17 shows to WGM spectra above lasing threshold of such beads in the two kinds of gelatin, respectively (5% (a), 3% (b)). Obviously, the WGMs, in particular of the lasing modes, have still excellent quality and thus may be exploited for sensing applications within the solid dense medium. Gelatin is made of collagen, which is a major tissue constituent. Thus, it is demonstrated that the globular microlasers of the present embodiments may be operated even in solid materials, such as those related to tissue, and thus may be applied, e.g., to biomedical applications as detailed above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method for analyzing a dense medium with optical cavity modes, comprising the steps of:
disposing at least a part of a microlaser into the dense medium; and
before, during, or after disposing the part of the microlaser into the dense medium, sensing a condition or a change of the dense medium by means of analysis of optical cavity modes.

2. The method for analyzing a dense medium with optical cavity modes according to claim 1; wherein,
the microlaser is a laser utilizing an optical cavity or microresonator as resonant structure for light recirculation and amplification, and
the optical cavity or the microresonator has a three-dimensional volume.

3. The method for analyzing a dense medium with optical cavity modes according to claim 2; wherein,
the largest extension of the three-dimensional volume has a value of 50 μm or below.

4. The method for analyzing a dense medium with optical cavity modes according to claim 2; wherein,
a plurality of the microlasers is at least partially disposed into the dense medium.

5. The method for analyzing a dense medium with optical cavity modes according to claim 4; wherein,
a cluster forms out of the plurality of microlasers, before, during, or after the plurality of the microlasers is at least partially disposed into the dense medium.

6. The method for analyzing a dense medium with optical cavity modes according to claim 4; wherein,
a plurality of clusters forms out of the plurality of microlasers, before, during, or after the plurality of the microlasers is at least partially disposed into the dense medium.

7. The method for analyzing a dense medium with optical cavity modes according to claim 4; wherein,
at least one of the microlasers is different from the other of the microlasers with respect to either size, shape, core, gain materials, and optional shell materials thereof.

8. The method for analyzing a dense medium with optical cavity modes according to claim 2; wherein,
the microlaser is moved by external forces or at rest at a target position.

9. The method for analyzing a dense medium with optical cavity modes according to claim 2; wherein,
the microlaser is at least temporally operated above a lasing threshold to achieve an acceleration of the sensing process.

10. The method for analyzing a dense medium with optical cavity modes according to claim 2; wherein,
the microlaser is immobilized in contact with at least a surface of the dense medium.

11. The method for analyzing a dense medium with optical cavity modes according to claim 10; wherein,
a part or constituent of the dense medium adsorbs to the microlaser.

12. The method for analyzing a dense medium with optical cavity modes according to claim 2; wherein,
a part of the microlaser is prepared for capture of a molecule, before, during, or after the microlasers is at least partially disposed into the dense medium; and
the molecule is sensed by analysis of the optical cavity modes.

13. The method for analyzing a dense medium with optical cavity modes according to claim 12; wherein,
the molecule is a biomolecule.

14. The method for analyzing a dense medium with optical cavity modes according to claim 12; wherein,
the process of capturing is mediated via binding between the molecule and the microlaser

15. The method for analyzing a dense medium with optical cavity modes according to claim 12; wherein,
the process of capturing is mediated via binding between the molecule and the microlaser

16. The method for analyzing a dense medium with optical cavity modes according to claim 12; wherein,
a plurality of the microlasers is at least partially disposed into the dense medium, and
at least a part of the microlasers is prepared for capture of target molecules.

17. The method for analyzing a dense medium with optical cavity modes according to claim 16; wherein,
a cluster forms out of the plurality of the microlasers forms, before, during, or after the plurality of the microlasers is at least partially disposed into the dense medium.

18. The method for analyzing a dense medium with optical cavity modes according to claim 16; wherein,
a plurality of clusters forms out of the plurality of the microlasers, before, during, or after the plurality of the microlasers is at least partially disposed into the dense medium.

19. The method for analyzing a dense medium with optical cavity modes according to claim 18; wherein,
a microlaser, which is constituent of a cluster of microlasers, is selectively operated above the lasing threshold for analysis of its optical cavity modes.

20. The method for analyzing a dense medium with optical cavity modes according to claim 19; wherein,
selective operation of the microlaser is achieved by selective powering of the microlaser or by selective operation of its gain material.

21. The method for analyzing a dense medium with optical cavity modes according to claim 1; wherein,
the dense medium is a biological material.

22. The method for analyzing a dense medium with optical cavity modes according to claim 1; wherein,
a radiation-induced event is initiated before, during, or after sensing the condition or the change of the dense medium.

23. The method for analyzing a dense medium with optical cavity modes according to claim 22; wherein,
the optically-induced event changes a property of the dense medium.

24. The method for analyzing a dense medium with optical cavity modes according to claim 23; wherein,
the optically-induced event is part of a therapeutic or medical treatment.
